(19) United States
(12) Patent Application Publication
(10) Pub. No.: US 2025/0210680 A1
(43) Pub. Date: Jun. 26, 2025

(54) TERRESTRIAL MICROBIAL FUEL CELL

(71) Applicants: Northwestern University, Evanston, IL (US); Georgia Tech Research Corporation, Atlanta, GA (US)

(72) Inventors: Josiah David Hester, Evanston, IL (US); George F. Wells, Evanston, IL (US); Bill Yen, Evanston, IL (US); Weitao Shuai, Evanston, IL (US); Nivedita Arora, Evanston, IL (US)

(21) Appl. No.: 18/989,416

(22) Filed: Dec. 20, 2024

Related U.S. Application Data
(60) Provisional application No. 63/613,519, filed on Dec. 21, 2023.

(51) Int. Cl. H01M 8/16; H01M 8/04537

(52) U.S. Cl. CPC H01M 8/16; H01M 8/04656; H01M 2250/10

(57) ABSTRACT

A microbial fuel cell includes a first conductive electrode that hosts a plurality of microbes that break down organic matter to perform oxidation and release electrons. The first conductive electrode is an anode. The microbial fuel cell also includes a second conductive electrode operatively coupled to the first conductive electrode. The second conductive electrode is a cathode that is vertically oriented in soil that includes the organic matter. Additionally, at least a portion of the cathode is contact with air.

### CROSS-REFERENCE TO RELATED APPLICATION

The present application claims the priority benefit of U.S. Provisional Patent App. No. 63/613,519 filed on Dec. 21, 2023, the entire disclosure of which is incorporated by reference herein.

### GOVERNMENT LICENSE RIGHTS

This invention was made with government support under CNS2038853 awarded by the National Science Foundation. The government has certain rights in the invention.

### BACKGROUND

A microbial fuel cell (MFC) is a type of bio-electrochemical fuel cell system which is also known as micro fuel cell. An MFC generates electric current by diverting electrons produced from the microbial oxidation of reduced compounds (also known as fuel or an electron donor) on the anode to oxidized compounds such as oxygen (also known as the oxidizing agent or an electron acceptor) on the cathode. Traditional MFCs utilize an external electrical circuit and produce electricity by using the electrons derived from biochemical reactions catalyzed by bacteria.

### SUMMARY

An illustrative microbial fuel cell includes a first conductive electrode that hosts a plurality of microbes that break down organic matter to perform oxidation and release electrons. The first conductive electrode is an anode. The microbial fuel cell also includes a second conductive electrode operatively coupled to the first conductive electrode. The second conductive electrode is a cathode that is vertically oriented in soil that includes the organic matter. Additionally, at least a portion of the cathode is contact with air.

In one embodiment, the device includes a scaffold, where the first conductive electrode and the second conductive electrode mount to the scaffold. The device can also include a gas exchange membrane mounted to the scaffold, where the gas exchange membrane is positioned between the scaffold and the cathode. In one embodiment, the gas exchange membrane comprises a 30% wetproofed carbon cloth. The device can also include a cap that mounts to the scaffold to help prevent material from entering the scaffold. In another embodiment, the scaffold includes an air chamber that includes air such that one side of the cathode is exposed to the air. In another embodiment, the air chamber is sealed such that the soil cannot enter the air chamber. In another embodiment, a top of the air chamber is open such that air can enter the air chamber.

In an illustrative embodiment, the anode is horizontally oriented in the soil such that the anode is perpendicular to the cathode. In another embodiment, the cathode is spaced apart from the anode such that there is a layer of the soil in between the cathode and the anode. In another embodiment, a sensor is connected to the device, where the sensor includes a capacitor that receives a direct current (DC) voltage from the device. In an illustrative embodiment, the sensor includes an oscillator that converts the DC voltage into an alternating current (AC) signal, and the AC signal has a frequency that changes depending on a capacitance of the capacitor in the sensor. Another embodiment includes a radio frequency (RF) analog switch and an antenna that is connected to the RF analog switch, where the AC signal is backscattered by the RF analog switch and provided to the antenna for transmission. In one embodiment, the capacitor includes an insulated wire in combination with a co-planar capacitor.

An illustrative method of forming a microbial fuel cell device includes forming a scaffold. The method also includes forming a first conductive electrode that hosts a plurality of microbes that break down organic matter to perform oxidation and release electrons, where the first conductive electrode is an anode. The method also includes forming a second conductive electrode as a cathode. The method further includes mounting the first conductive electrode and the second conductive electrode to the scaffold such that the second conductive electrodes is operatively coupled to the first conductive electrode. The second conductive electrode is mounted to the scaffold such that the second conductive electrode is vertically oriented in soil that includes the organic matter.

In an illustrative embodiment, forming the scaffold includes forming an air chamber in the scaffold. In such an embodiment, the second conductive electrode is mounted to the scaffold such that at least a portion of the second conductive electrode is in contact with air in the air chamber. The method can also include mounting a gas exchange membrane to the scaffold such that the gas exchange membrane is positioned between the air chamber of the scaffold and the cathode. The method can also include mounting the anode to the scaffold such that the anode is horizontally oriented in the soil and such that the anode is perpendicular to the cathode. The method can also include mounting the cathode to the scaffold such that the cathode is spaced apart from the anode and such that there is a layer of the soil in between the cathode and the anode. In such an embodiment, the layer of soil operatively connects the cathode to the anode. The method can further include connecting a sensor to the device, where the sensor includes a capacitor that receives a direct current (DC) voltage from the device.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts an iterative design process based on a vision of sustainable, soil-powered distributed sensor networks to produce an improved SMFC prototype in accordance with an illustrative embodiment.

FIG. 2 shows a diagram of a soil-based MFC in accordance with an illustrative embodiment.

FIG. 3 is a table that compares various ambient energy harvesting sources in accordance with an illustrative embodiment.

FIG. 4A depicts a first prototype including an anode, air cathode, scaffold, and clips that secure the electrodes to the scaffold in accordance with an illustrative embodiment.

FIG. 4B depicts a second prototype with vertical electrodes with an air chamber to expose one side of the cathode to air in accordance with an illustrative embodiment.

FIG. 4C depicts a third prototype with a horizontal anode with 5 centimeters (cm) of soil above to insulate it from oxygen in accordance with an illustrative embodiment.

FIG. 5 depicts a v0 control study data demonstrating the sharp drop in power despite no obvious change in bulk volumetric water content, suggesting that the regional decrease in soil moisture affected the cells' power outputs in accordance with an illustrative embodiment.

FIG. 6 depicts v1 cell performance showing no clear microbial activity after 40 days of incubation due to the possible infiltration of oxygen to the anode in accordance with an illustrative embodiment.

FIG. 7 depicts v2 cells vs. v0 cells across two moisture cycles in accordance with an illustrative embodiment.

FIG. 8A depicts the air cathode, soil, anode, ABS scaffold, and air chamber sealed against the soil environment on the cathode side, only exposing one face of the cathode to air in accordance with an illustrative embodiment.

FIG. 8B depicts the 316 stainless steel flange, carbon felt electrode, 30% wetproofed carbon cloth membrane, and ABS scaffold of the v3 design in accordance with an illustrative embodiment.

FIG. 8C depicts an isometric view of the assembly in accordance with an illustrative embodiment.

FIG. 9 depicts power from v3 cells vs. v0 cells across four moisture cycles in accordance with an illustrative embodiment.

FIG. 10 depicts power output comparison of v0 and v3 cells as a function of VWC during the second drying period, where the v3 cells were able to perform at a 4% lower VWC, making them more robust to lower soil moisture levels in accordance with an illustrative embodiment.

FIG. 11 depicts a summary of the key design issues and improvements in accordance with an illustrative embodiment.

FIG. 12 is a schematic of the 3-electrode SMFC configuration to measure anode and cathode potentials relative to the reference electrode (E and E⁺ respectively) in accordance with an illustrative embodiment.

FIG. 13 depicts a suggested framework for identifying weaknesses in SMFC design and iteratively improving the SMFC in accordance with an illustrative embodiment.

FIG. 14 depicts that soil texture variation can vastly affect cell performance in accordance with an illustrative embodiment.

FIG. 15 depicts how a poor connection between the load circuit and the carbon felt electrode can result in increasing voltage, which throws off the power measurement in accordance with an illustrative embodiment.

FIG. 16 depicts a schematic of a simulated setup in which the SMFC is the Energy Source, the harvester, storage capacitor C, and switch are the Energy Buffer and Charge Controller, while the Energy Consumer varies based on the application in accordance with an illustrative embodiment.

FIG. 17 illustrates the daily number of discrete events the intermittent devices could complete given the energy input from the v3 SMFCs in accordance with an illustrative embodiment.

FIG. 18 examines how often MARS would run assuming it was directly powered by the SMFC with no harvesting or storage in accordance with an illustrative embodiment.

FIG. 19 depicts the daily number of operations from minimal and advanced configurations powered by a v0 or v3 cell in accordance with an illustrative embodiment.

FIG. 20 depicts exploded and assembled views of the v3.1 SMFC modified from v3 cells to make it leak-proof and improve its mechanical strength for outdoor deployment in accordance with an illustrative embodiment.

FIG. 21 is a top view of the v3.1 cell buried outside in an irrigated residential yard in accordance with an illustrative embodiment.

FIG. 22 depicts that the power level of the incubated v3.1 cell dropped significantly after being transplanted outside in accordance with an illustrative embodiment.

FIG. 23 depicts a SMFC+MARS system diagram in accordance with an illustrative embodiment.

FIG. 24 depicts the backscatter setup including two patch directional antennas on MARS and Rx (Taoglas Limited ISPC.91A.09.0092E) and a monopole antenna on Tx (Great Scott Gadgets ANT500) in accordance with an illustrative embodiment.

FIG. 25 is a plot of the signal-to-noise ratio (SNR) of the backscattered signal with the corresponding power and VWC measured for the SMFC in accordance with an illustrative embodiment.

FIG. 26 depicts results of a user grabbing the sensing wire with their hand twice, which correlates with the two dips in backscatter frequency in accordance with an illustrative embodiment.

FIG. 27 depicts results of soil moisture sensing with MARS powered by a v3.1 SMFC in accordance with an illustrative embodiment.

FIG. 28 is a table depicting materials used to construct a soil microbial fuel cell in accordance with an illustrative embodiment.

FIG. 29A is a table depicting 3D printing specifications for a v3.1 cell in accordance with an illustrative embodiment.

FIG. 29B is a table depicting 3D printing specifications for a v0 cell in accordance with an illustrative embodiment.

FIG. 30 depicts exploded and assembled views of a v0 SMFC in accordance with an illustrative embodiment.

FIG. 31 depicts a comparison of a conventional SMFC to the proposed SMFC in accordance with an illustrative embodiment.

### DETAILED DESCRIPTION

As the consequences of climate degradation become increasingly prominent, it is imperative for society to find sustainable alternatives to power the ever-growing need for computation. Soil Microbial Fuel Cells (SMFCs) are a promising source of renewable energy in applications where regular chemical batteries and solar panels fall short, such as in green infrastructures, wetlands, or underground. Solar panels are prone to getting covered by dirt or foliage in wet locations with vegetation and do not work at night, while batteries contain contaminants that may leach into the environment if they were not retrieved. Furthermore, they both require high-impact minerals like tin and cobalt that impose heavy negative externalities on the environments they are harvested from. SMFCs generate power using the naturally occurring microbes in their environment. They can be made from many types of locally sourced, biomass-based materials with significantly smaller, if not negative, carbon footprints. They can also be deployed almost anywhere there is soil and are highly scalable since they do not require raw materials with complex external supply chains like lithium or silver. SMFCs have been demonstrated to produce as much as 200 microwatts (μW) of power with an open-circuit voltage upwards of 731 millivolts (mV) under optimal, carefully-controlled conditions. This theoretically makes SMFCs a viable option in solving the critical bottleneck in expanding the growth of smart cities and farms: the lack of decentralized, long-term, and renewable power. Overcoming this restriction will push the ubiquitous computing community closer to battery-free computational devices capable of perpetual deployment, which would enable reliable real-time monitoring of various environmental conditions that could then be used to drive policy and engineering decisions.

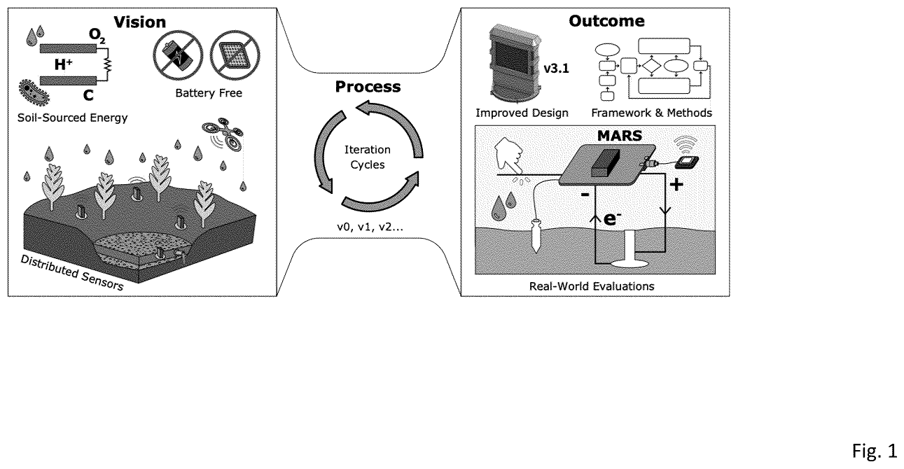

While the promises of SMFCs are very real, the reality of their performance outside of the lab is not ideal. The concept of microbial fuel cells has existed since 1911, but their highly variable power output has hindered the computing community from making practical use of them. SMFCs are susceptible to changes in environmental conditions, with soil moisture being a particularly strong limiting factor. This makes efforts to deploy true terrestrial SMFCs as energy sources in the field an ongoing challenge, with no current example of a SMFC that can generate consistent amounts of power long-term outside of inundated conditions. Although there have been attempts to improve SMFC design, there is an absence of reliable comparative studies in the literature regarding the effects of cell designs on power output and their resiliency to changes in soil moisture. As SMFCs are heavily affected by environmental conditions, types of soil, and the microbial communities that inhabit them, any evaluation done outside of direct comparisons in the same environment holds little meaning. While many novel SMFC designs have been proposed, they are rarely tested against each other systematically to identify their relative strengths and weaknesses. To resolve this roadblock in the development of this sustainable energy source for ubiquitous computing, the inventors explored the SMFC design space in a principled manner via a 2-year-long iterative design process with a combined nine months of SMFC deployment data. This iteration process spans four separate experiments and examines the relative performances of 4 distinct SMFC configurations in a common environment. The experimental framework utilizes fundamentals of electrochemistry and MFC theory and led to a design that enables stable operation under soil with 4% lower volumetric water content (VWC) than the minimum VWC required for benchmark cells, which increases SMFC's applicability in grasslands and wetlands with seasonal swings in soil moisture. This greater operational moisture range translates to 40% more computing operations in simulation for digital systems and a 120% increase in theoretical runtime for analog sensors throughout its 161-day lab deployment. The inventors further evaluated the feasibility of this new SMFC design with a combination of an outdoor deployment in real-world settings and bench-scale studies powering an analog backscatter sensor. FIG. 1 depicts an iterative design process based on a vision of sustainable, soil-powered distributed sensor networks to produce an improved SMFC prototype in accordance with an illustrative embodiment. As discussed below, the inventors conducted real-world evaluations on the feasibility of SMFCs as energy sources with an outdoor deployment and by integrating SMFCs with low-power analog wireless sensors.

The proposed system utilizes an SMFC as a power source. Specifically, the proposed SMFC can be used as an energy source for computational sensing systems and the inventors have identified a confluence of factors that finally make this concept relevant for practical usage in computing. In developing the system, the inventors reviewed the state-of-the-art designs of SMFCs and the gaps and challenges that remain in SMFC development. The above-discussed iterative design process was utilized, with nine months of combined deployment data to develop usable, computing-centric SMFCs more robust to soil moisture variations. The inventors empirically explored the impact of soil moisture on SMFC performance, and the proposed system is an improved SMFC design that can operate at lower moisture levels and produce more energy, which enabled 40% more computing operations for digital systems and 120% longer runtime for analog systems in simulation than the benchmark cell throughout a 161-day experiment. To test the framework, the inventors identified a systematic method to improve the SMFC design by analyzing the performance of its individual electrodes, explaining common experimental pitfalls, and presenting a direct comparison of different cell geometries in lab settings to develop a working prototype as a soil-powered energy source. The inventors also contextualized the improvements from the new design with a runtime simulation, evaluated the SMFC under field conditions, and integrated the new SMFC prototype with ultra-low power analog backscatter sensors to gauge the feasibility of soil-powered sensing systems.

It is only recently that computers have entered the power envelope where the amount of energy generated in MFCs (hundreds of microwatts) is enough to power practical applications. The rise of low-power Internet of Things (IoT) technologies and distributed sensor networks has sparked an increasing demand for decentralized and renewable sources of energy. Despite their promise, most MFC designs are not optimized to produce stable power under dynamic environments with variable moisture contents, which is where these low-power sensors would typically be deployed (e.g., farms, wetlands, etc.). Because MFCs produce power on the microwatt scale, there is also a need to re-examine the fundamentals of current computing and communication methods in order to leverage this ultra-low energy budget. Discussed below is the theory behind MFCs' operation and the key factors that affect their performance, the knowledge gaps of existing system, the unique benefits of SMFCs as energy sources, and current limitations of soil-powered computational systems.

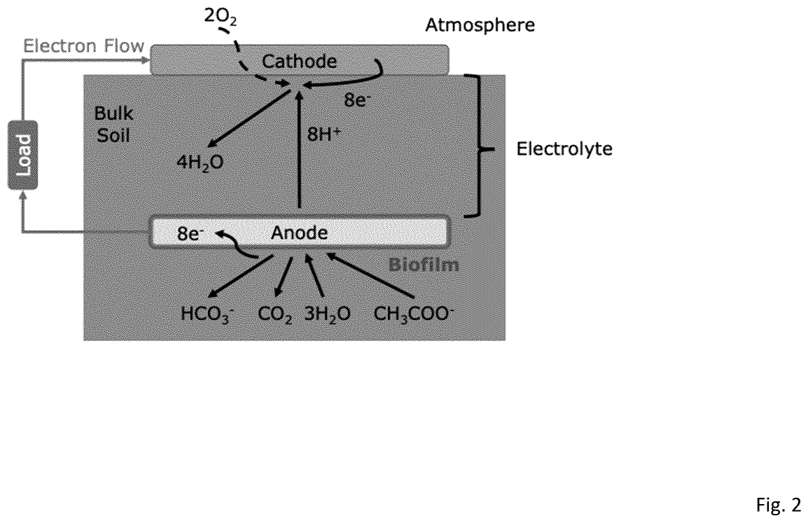

The key components of an MFC are the anode, cathode, and the electrolyte between these electrodes. FIG. 2 shows a diagram of a soil-based MFC in accordance with an illustrative embodiment. In a SMFC, the biofilm growing on the anode oxidizes organic matter to release electrons, which becomes the source of electrical power. The cathode performs a reduction reaction to balance out the cell's net charge, which requires oxygen as a reactant. The electrolyte facilitates ion exchange between the anode and cathode while preventing oxygen from penetrating into the anode. These cells operate similar to a battery, except they produce power using the organic carbons from the environment instead of depleting the reactants within. In an MFC, organic matter is oxidized by exoelectrogens, which are bacteria that can transfer electrons extracellularly. They are found ubiquitously in most wastewater and soil. The extracellular electrons are then released to a solid-state anode, and travel through a circuit to the cathode, where they reduce O₂ into H₂O while consuming a H⁺ in the cathodic half reaction. This process results in a potential difference between the anode and cathode, leading to a source of electrical power. This cell potential equals the difference between the two half-reaction potentials. Using acetate as a simplified representation of the organic growth substrate oxidized at the anode, the overall reaction for the MFC can be written out as:

CH₃COO⁻+2O₂→CO₂+HCO₃⁻+H₂O Equation 1:

This can be further broken down into two half-reactions happening at the electrodes. The oxidation half-reaction on the anode side is:

CH₃COO⁻+3H₂O→CO₂+HCO₃⁻+8H⁺+8e⁻ Equation 2:

On the cathode, the reduction half-reaction is represented as:

2O₂+8H⁺+8e⁻→4H₂O Equation 3:

The SMFC anode can be made from almost any conductive material microbes can grow on. Carbon felt is a popular choice because of its high specific surface area, affordability, low environmental impact, and inert properties. The performance of SMFCs is directly related to the health and activity of the exoelectrogenic biofilm on the anode. Exoelectrogens grow best under anoxic conditions (e.g., in the absence of oxygen), which means that the anode is usually kept away from the atmosphere in MFC designs.

The cathode can likewise be made from the most inert, conductive materials. MFC cathodes can be made of anything from carbon and metal-based materials to biocatalysts, though biological activity is not necessary for the cathodic reaction to occur. The cathodic reaction is typically what determines the MFC's power output and energy efficiency as it is where the largest over-potential, a factor that decreases harvestable potential, occurs. SMFCs use air (O₂) as the terminal electron acceptor, so the cathode often is made of a gas-permeable material to allow for oxygen flow (see FIG. 2).

Ensuring the cathode's access to oxygen while maintaining an anoxic anode environment requires an electrolyte between the anode and cathode. SMFCs use a layer of soil as the electrolyte. This electrolyte has to accomplish three tasks: (1) prevent oxygen from penetrating to the anode, (2) insulate the electrodes from one another, and (3) allow ions to diffuse between the electrodes. Without transporting the protons away, the area surrounding the anode will become acidic, negatively affecting the health of the exoelectrogens in the biofilm. An ion exchange membrane can perform the aforementioned functions in an MFC, but the capital cost can be substantial. In SMFCs, oxygen is consumed by aerobic microbes to create an anoxic condition in a deep layer of soil, while the porous structure of the soil matrix allows for ion exchange and prevents shorting between anode and cathode. Whether or not shorting occurs depends heavily on the conductivity of the electrolyte and the separation distance between the electrodes.

SMFC performance is a function of various factors like temperature, soil organic matter content, pH, and soil moisture. The exact model of how any of these parameters affect SMFCs is largely unknown, as even the full diversity of exoelectrogens that SMFCs harness is uncharacterized. Each type of microbe may follow a different metabolic pathway, which currently limits the prediction of SMFC performance using these factors to just general trends. Because the anodic reaction is dependent on microbial activity, increasing the surrounding soil temperature tends to increase the power output of SMFCs, but only up to a certain point (about 36° C.). Since organic carbons species serve as an essential reactant for the anodic reaction, the presence of soil organic matter can also boost the performance of SMFCs. Many groups of exoelectrogens prefer a slightly acidic pH, though it is not well-understood whether a lower soil pH always leads to a higher peak voltage and charge due to the complex nature of soil chemistry.

Furthermore, there appears to be a minimum soil moisture content that SMFCs require before sharply declining in energy output (about 20% water by weight), which is a significant limiting factor in terrestrial applications where the soil is not saturated. The soil between the electrodes serves as the electrolyte for SMFCs, so desaturating the soil will cause the liquid phase within the soil pore network to discontinue, drastically reducing ion transport and electricity generation. The SMFCs characterized using soil as the electrolyte experienced a steep drop-off in open circuit voltage with 50% volumetric water content (VWC). Even SMFCs that use special membranes instead of soil as the electrolyte reported similar results of high soil moisture sensitivity below 48% VWC, making them not viable in many applications. As such, designing SMFCs that are more robust to lower VWC is a highly-motivating yet difficult challenge that is addressed herein. The general effects of these environmental parameters on SMFCs indicate that temperature is positively correlated with power output and that power begins to decrease above an upper temperature limit, that organic matter content is positively correlated with power output, that soil pH is negatively correlated with power output (there is not always a clear relationship in practice), and that soil moisture content is positively correlated with power output (there is a sharp drop off after a minimum threshold).

Although several papers have been published on using MFCs as power sources, they have mainly been done with purely aqueous or sediment MFCs in wastewater or marine settings, which are quite different from terrestrial environments. Until recent early-stage work, studies geared toward agricultural applications have been limited to crops that prefer inundated environments like rice. Existing papers have demonstrated a strong relationship between soil moisture content and the power output of SMFCs, but none has attempted to reduce the power drop caused by decreasing soil moisture to optimize for robust energy production. Some works have implemented strategies like changing the spacing between the electrodes, using different materials for the anode and cathode, and dosing catalysts and nutrient supplements to the cells to improve their relative power output, but only under constant soil moisture. There is a clear need to improve SMFC design for power generation in drier terrestrial environments to bring them into practical use. A key bottleneck in designing better SMFCs in the existing literature is the lack of robust comparative studies. The design works outlined above do not perform direct comparisons on how they improve from standard configurations or even explain how they arrive at their prototype. For example, Apollon et al. somewhat explored the effects of soil moisture on the power output of SMFCs in terrestrial environments with their novel SMFC that generates electricity in semi-arid soil. However, their comparison between their cell and those from the existing literature involved many uncontrolled variables, such as soil type, moisture content, temperature, and the microbial communities that generate power in these experiments. Because the power output of SMFCs depends on all of these environmental factors, it would not be fair to evaluate the relative performances of different designs based solely on power production when other variables are not held constant. For example, while the SMFCs from one work achieved a maximum power density of 108 mW/m², this does not necessarily mean they are better at energy production than another that only produced 28.6 mW/m². The testing conditions between these studies were vastly different, making generalizing performance from comparing these bespoke experiments impossible. This makes it difficult for SMFC researchers to build on top of each other's work and even harder for the computing community to determine the best SMFC for their application.

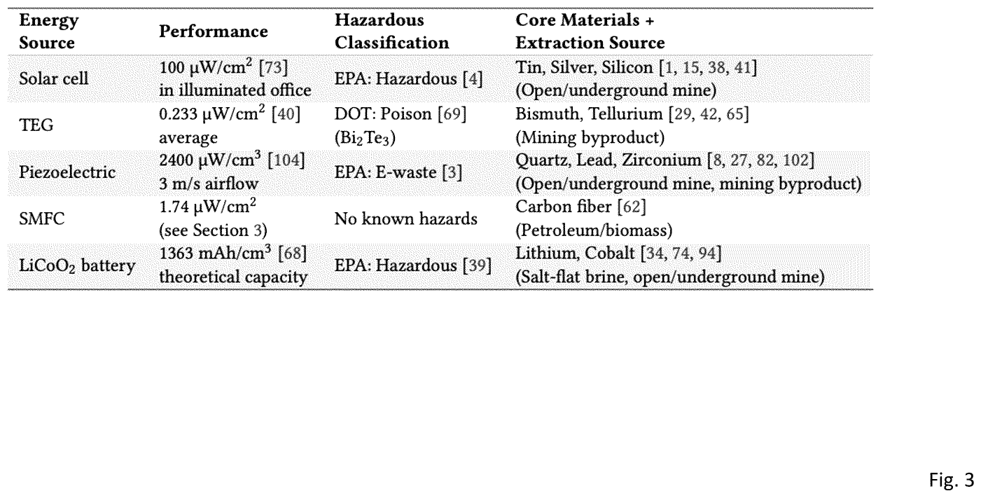

SMFCs contain comparable energy density to thermoelectric generators (TEGs) and some piezoelectric devices, but orders of magnitude less power than silicon solar cells. However, SMFCs can provide key advantages over existing energy sources from both sustainability and practical standpoints. Their relatively harmless source materials mean they are less likely to threaten their environment. SMFCs do not contain any component classified by the U.S. Environmental Protection Agency (EPA) or Department of Transportation (DOT) as possibly dangerous, which makes them safer for at-scale deployments in protected ecosystems and farmlands. FIG. 3 is a table that compares various ambient energy harvesting sources in accordance with an illustrative embodiment. As shown, SMFCs are appealing as a ubiquitous energy source due to their low toxicity and hazards, minimally impactful core materials, and competitive performance relative to piezoelectric and TEG.

Furthermore, the expansion of IoT into increasingly diverse applications has created a need for alternative ambient harvesting sources. For example, farmers or scientists interested in monitoring the soil conditions near certain canopy-dense plants cannot always afford to erect solar panels on tall platforms above the plants for fear of disrupting the plants' growth. In contrast, SMFCs require no ambient light and can be installed underground to avoid unwanted attention. While TEGs can also work under similar conditions by harvesting from the small thermal differential between soil and air, many designs feature heat exchange pipes upwards of 3.5 meters long, which makes their installation laborious and disruptive to the environment.

Prior computational systems that use SMFCs as energy sources use highly controlled (i.e., wet) environments to increase energy output, and a common dilemma they face is the trade-off between functionality, performance, and runtime. For example, basic e-ink displays powered by an array of SMFCs may manage to operate for longer periods, but their capabilities are restricted to simple timekeeping and display. More sophisticated systems only transmit about three data points every two hours due to high power demand, and other MFC-powered systems showed similar trends despite leveraging ultra-low power microcontrollers like MSP430. Even wireless protocols like Zigbee and LoRa, which are specifically designed for low-power applications, struggle to meet the meager energy budget typical SMFCs provide. The MRF24J40MA Zigbee transceiver benchmarked by Pietrelli et al. draws up to 23.3 mA during transmission, which is many orders of magnitude larger than the 557 μA their SMFC generated. Likewise, LoRa-based systems could only achieve a maximum of five transmissions per day despite being connected to an array of three SMFCs. This limits these devices' ability to provide real-time data, which may be critical for implementing a flood sensing application.

Although advances in digital electronics made it possible to intermittently power small devices using SMFCs, microcontrollers and radio transmitters are still very costly to implement energy-wise. It is possible to use an RF backscatter to transmit sensor data in SMFC-powered systems, which is built upon in the proposed system. Backscatter operates on the order of nanowatts, making them suitable for SMFC-powered applications. Through the use of a purely analog backscatter device like MARS, it is expected to have near-continuous runtime with just the power from a single SMFC, assuming it is not dried out. Analog backscatter devices offer unmatched performance in terms of runtime availability and robustness without using batteries and storage capacitors, making them a more viable choice for the real world. An in-depth assessment of integrating MARS with SMFC is explored below.

While the theory of SMFCs is fairly simple, the challenge of implementing a robust working cell has impeded research into soil-powered computing. Previous studies have tried to use low-performance, basic cells that were originally designed for contaminant removal, and had to maintain inundated environments to achieve high power output. The works that have proposed different SMFCs rarely examine their relative strengths and weaknesses and never explain their design rationales. This has made SMFC a difficult subject for non-experts to explore. Described below are design goals and the challenges that must be overcome to enable soil-powered computing as a field. Design Goal #1, Robustness: Improve the SMFC's power output continuity by increasing its robustness to soil moisture variations. This is difficult due to the soil electrolyte's dependence on water for ion transport. Extending the moisture range at which SMFCs can operate will make them more stable power sources, which is vital to implementing reliable SMFC-powered sensors. Design Goal #2, Reproducible and Understandable: Establish a framework for experimental procedures to streamline the process of testing different SMFC designs. Standardizing SMFC experiments is challenging because of the number of variables involved that affect their performance (specific soil used, electrode alignment, temperature, etc.). Having a well-tested experimental setup with examples of common pitfalls and how to debug them will make the complex nature of SMFC design involving wet lab work, electronics prototyping, and living organisms more accessible to the computing community. Design Goal #3, Accessible and Local Supply Chains: Provide easily manufacturable baseline SMFCs for future work. Most SMFCs in literature are not well-characterized in terms of construction and performance under dynamic conditions. As such, creating easily-reproducible SMFCs with purely off-the-shelf and 3D-printable components that have also been tested under a variety of moisture conditions will enable researchers to compare their own designs with these as benchmarks.

Toward these goals, the inventors implemented a 2-year-long iterative design process of prototyping and data collection to improve the robustness of SMFCs by altering their electrode geometry. A preliminary study was conducted to characterize common issues with traditional SMFC designs. The inventors then conducted a series of iterations where the geometry of the SMFCs was modified to optimize their computationally usable energy output for lower moisture environments. The SMFC designs explored features the following: v0: Horizontal anodes and cathodes (control) v1: Vertical cathodes with vertical anodes v2: Vertical cathodes with horizontal anodes v3: Horizontal anodes with one side of the vertical cathodes permanently exposed to air.

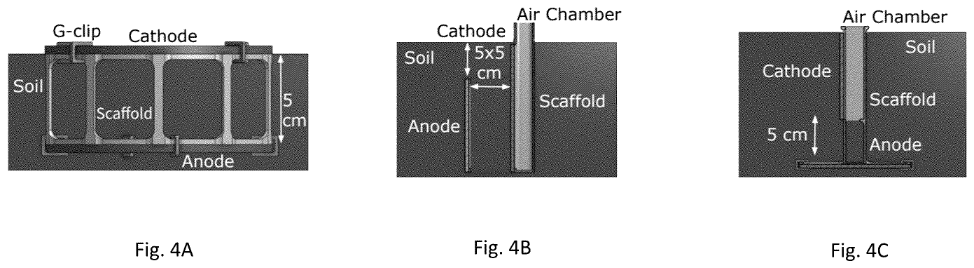

The first three versions of the SMFC served as vital benchmarks to point out shortcomings in the concepts, which led to a final v3 prototype. FIG. 4A depicts a first prototype including an anode, air cathode, scaffold, and clips that secure the electrodes to the scaffold in accordance with an illustrative embodiment. FIG. 4B depicts a second prototype with vertical electrodes with an air chamber to expose one side of the cathode to air in accordance with an illustrative embodiment. FIG. 4C depicts a third prototype with a horizontal anode with 5 centimeters (cm) of soil above to insulate it from oxygen in accordance with an illustrative embodiment. In FIG. 4C, the scaffold has an open top that lets O₂ enter. The iterative design work on SMFC distinguishes itself by focusing on directly comparing the performance of SMFCs with different electrode geometries against each other given identical environmental factors. This serves as a more practical guide toward designing soil-powered energy sources for computing in remote terrestrial environments.

All of the experiments were carried out in a lab at room temperature (20±1.5° C.). A Raspberry Pi 3B along with 16-bit ADS1115 analog to digital converters were used to record the median voltage values of each cell every minute. To avoid any confounding of electrochemical corrosion, titanium wires (Ultra-Corrosion-Resistant Grade 2 Titanium Wire 0.025″ Diameter) insulated with polyolefin heat shrinks (Digi-Key Q2F364B-100-ND) were used to connect the electrodes of the SMFCs to external electronics. The titanium wires were used for experimental evaluations only and can be replaced with carbon-based conductors for real deployments. The electrodes were made from 4.5 mm carbon felt (G600 AvCarb Soft Graphite Felt). A 2 kiloohm (kΩ) resistor connected the anode and cathode of each SMFC. This load was chosen to maximize the power produced by the cell. The soil used for these experiments was collected, air-dried, and sieved through a 2 mm mesh to remove large particles such as gravel, rocks, and any plants and insects. Before the SMFCs were installed, deionized water was added to the soil to reach the target soil water content, and the mixture was thoroughly stirred until it became a homogeneous slurry. All of the cells featured a constant 5 cm anode-cathode separation with a base surface area of 126.7 cm² per electrode unless otherwise mentioned, which prevents the electrodes from shorting and ensures sufficient surface area for exoelectrogens to colonize.

During the startup periods of the experiments, the soil was kept flooded with the top of the bulk container partially closed to slow the rate of evaporation. In order to better understand and improve upon the weaknesses of traditional SMFCs, the inventors first benchmarked a design inspired by the Mudwatt, a commercial SMFC from Magic Microbes. In the experiment, two identical carbon felt disks with a diameter of 12.7 cm were used as the anodes and cathodes of the SMFCs. The cathodes (top carbon felt disk) were kept exposed to the air while the anodes (bottom carbon felt disk) were buried in the soil under anoxic conditions (see FIG. 4A). A TEROS-12 sensor from METER was used to monitor the bulk volumetric water content (VWC) of the setup.

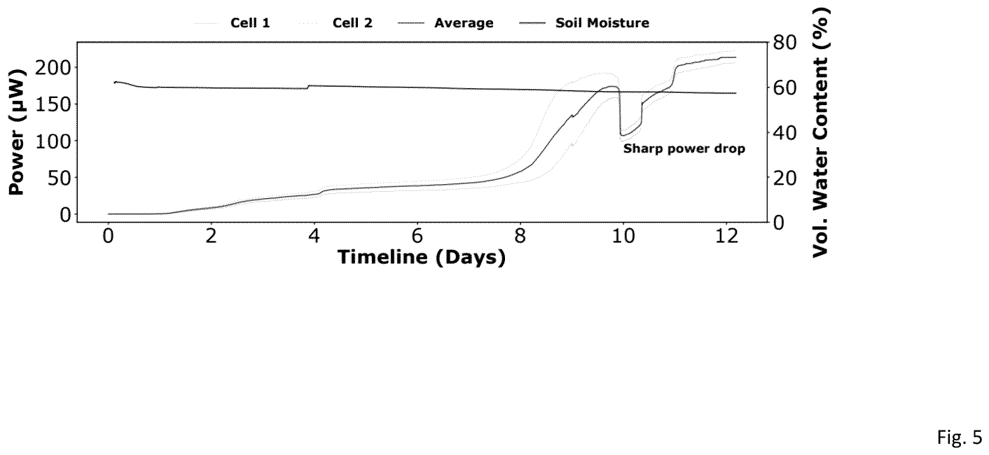

Over the course of the experiment, Cell 2 produced upwards of 222 μW with a power density of 1.74 μW per cm² of geometric cathode surface area at its peak. Power density is normalized to cathode surface area because the cathode is usually the limiting factor in MFCs. FIG. 5 depicts v0 control study data demonstrating the sharp drop in power despite no obvious change in bulk volumetric water content, suggesting that the regional decrease in soil moisture affected the cells' power outputs in accordance with an illustrative embodiment. FIG. 5 shows that even though the bulk VWC of the setup was held relatively constant, there was a sharp decrease in power production around day 10 of the experiment. It was observed that the top 1 cm of the soil dried up around that time, leaving the cathode cut off from the water-saturated portion of the environment. It is likely that this regional decrease in soil moisture content disrupted the ion transport in the electrolyte, thus breaking the reaction necessary to generate electricity. As such, a series of design iterations was performed to explore three new SMFC prototypes with different anode and cathode orientations to address this issue. In the subsequent experiments, this v0 cell with horizontal anode and cathode served as the control for the new designs. 3D-printed scaffolds made of plant-based PLA plastic were added to the design to aid with their installation (see FIG. 4A).

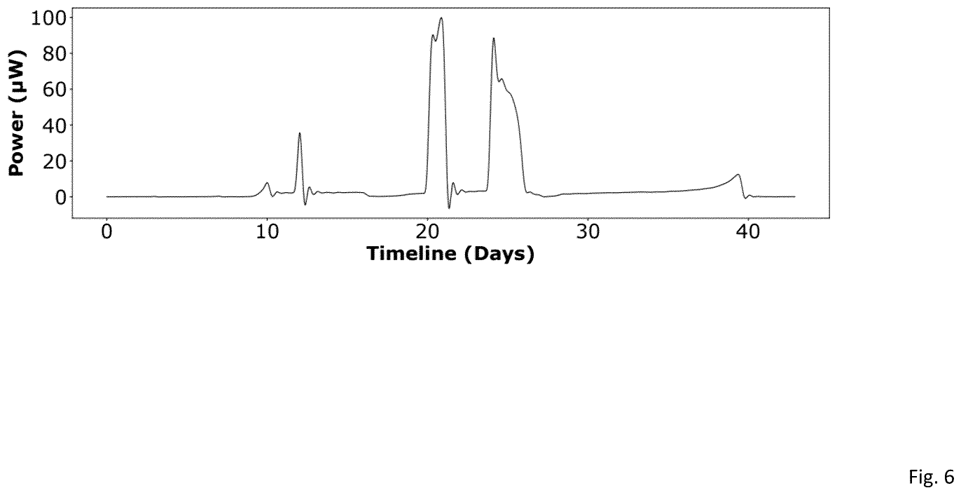

The v0 cell power outputs drastically decreased after the top layer of soil dried out. This reduced the output power to zero despite an abundance of moisture in the environment. As such, the design must prevent the electrolyte from drying out and cutting off ion exchange between the electrodes. In order to prevent the sudden cutoff in power after the top layer of soil dries, the inventors decided to rotate both electrodes so that they lie perpendicular to the soil surface (see FIG. 4B). This means that as water evaporates from the soil, both electrodes would still sit partially in the water-saturated region, theoretically allowing ion transport to happen as long as the cell was not completely dried out. One side of the cathode is kept in contact with soil, while the other side is exposed to air using an air chamber formed by the PLA scaffold. The surface area of the anode was kept the same as the anodes, while the cathode was made slightly larger to allow it to extend closer to the soil line. One cell was kept under inundated conditions in the lab to test the viability of this design. FIG. 6 depicts v1 cell performance showing no clear microbial activity after 40 days of incubation due to the possible infiltration of oxygen to the anode in accordance with an illustrative embodiment. This iteration is insightful for determining the best configuration for the anode, which was implemented in the v2 SMFC prototype. As one can see in FIG. 6, the v1 cell performed far less reliably than the v0 cells benchmarked earlier. Even though it was kept in the same type of soil, it never established a consistent power output, and the voltage readings between the electrode did not indicate the steady microbial growth that typical SMFCs have.

In order to debug this issue, the inventors measured the potential of both the cathode and anode relative to an AgCl electrode (BASi MF-2052) placed very close to the electrode in question. It was found on day 20 of the experiment that the cathode to reference potential was 311.7 mV while the anode to reference potential was 216.3 mV. Since the anode potential was relatively high (indicating a lack of oxidation reaction happening), it was hypothesized that flipping the anode vertically had a negative effect on its performance, and this was adjusted for the next design. One possible explanation for this reduced anode performance is that the vertical anode may contain less surface area in an anoxic environment, limiting exoelectrogenic activity.

The anode performance of v1 cells was poor, and the overall cell output was very inconsistent despite constant environmental parameters. The vertical arrangement of both electrodes might have somehow encouraged the formation of small cracks in the soil that transported oxygen to the anode. A new SMFC iteration utilizes a horizontal disk identical to the v0 electrodes for its anode and a rectangular carbon felt perpendicular to the anode and equal in surface area as its cathode (see FIG. 4C). One side of the cathode is kept in contact with soil, while the other side is exposed to air using an air chamber formed by the PLA scaffold. All of the v0 control cells and v2 cells were placed within the same bulk container (6 cells total) and flooded until the water level sat just below the control cells' cathodes. The container was then covered with a plastic tarp until all of the cells reached steady state. After that, the tarp was removed to allow water to evaporate in order to characterize the SMFCs' behaviors across a range of soil moisture values. The inventors performed the moisture cycle twice to observe how different cell types rebound from drying.

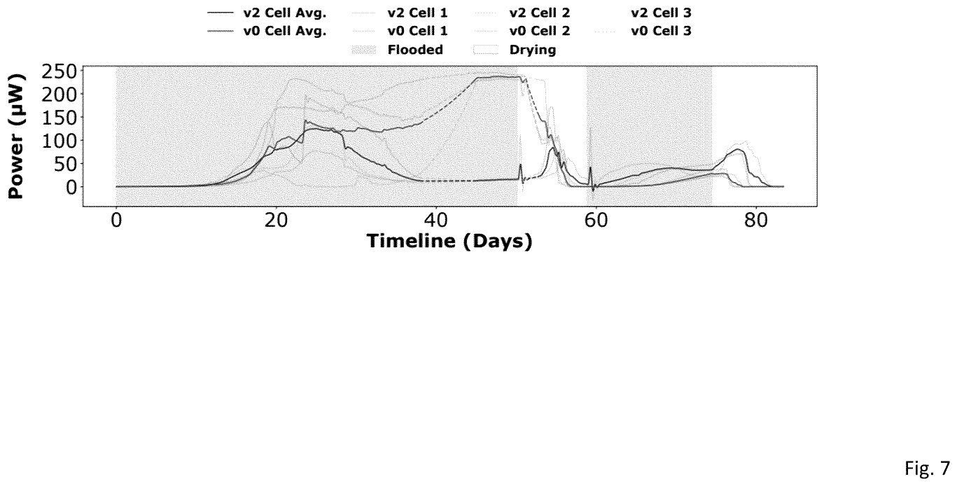

FIG. 7 depicts v2 cells vs. v0 cells across two moisture cycles in accordance with an illustrative embodiment. Cycle 1 is from day 0 to day 52, and Cycle 2 is from day 53 onward. The v2 cells showed increasing power during drying cycles and recovered better from drought, demonstrating the promise of altering to a vertical cathode geometry. However, the vertical v2 cathodes being completely submerged during flooded periods caused their performance to suffer, which is addressed through a v3 prototype discussed below.

During the initial startup phase, the v2 cells seemed to follow a similar trend to the controls. However, their powers steadily declined after day 32 of being kept in flooded conditions, while the controls maintained their output for the most part. In the first drying period, all of the control cells' outputs dropped steeply to almost zero. The v2 cells, on the other hand, experienced a boost in power before declining with their neighbors. This same pattern can be seen in the second drying cycle, and the v2 cells also seemed to recover faster than the controls after being dried out, although all 6 cells had the highest power outputs during the initial flooded period. The relatively linear trends from days 38-45 and 50-53, represented by dashed lines, are extrapolated due to data loss from a logger malfunction.

Throughout the experiment, the air chambers of the v2 cells were flooded with water, placing the cathodes partially underwater. This was especially apparent during the flooded part of the moisture cycles, where the air cathodes were entirely submerged at times. Because the cathodic reaction requires oxygen, partially submerging the cathode would reduce its effective surface area and the cell's power output. While oxygen could still diffuse into the water in the air chamber from its surface, it would quickly be used up by the aerobes breaking down the soil underneath in an established system, which could explain the delayed drop in power for almost 33 days. During the first flooding period (day 36), v2 Cell 2 had anode and cathode potentials of −463.3 mV and −338.8 mV respectively relative to a AgCl reference electrode, while v0 Cell 2 had anode and cathode potentials of −435.7 mV and 92.1 mV respectively. This further suggests that the issue lies with the cathode, as the two cells' anode potentials were relatively the same while the v2 cell's cathode had a much lower potential.

Although the v2 cells did worse than the controls when the enclosure was flooded, they achieved better theoretical runtime than the v0 cells during both drying periods and the second flooded period. This indicates that a vertical cathode geometry allowed the cells to function at more dynamic moisture conditions. In order to take advantage of this added robustness from the vertical cathode design while also maintaining steady performance in flooded soil, the air chamber was sealed from the environment for the next iteration.

In the v2 cells, water was able to infiltrate the air chamber through the bottom of the scaffold and the porous cathode itself (see FIG. 4C). The air cathodes get submerged in water during flooded periods, which limits the cathode's access to oxygen, consequently reducing the cathodic reaction rate. The inventors ensured the air cathode's access to oxygen in this iteration by extending the 3D printed scaffold to enclose the bottom of the chamber, thereby sealing the air chamber from the soil environment. This scaffold was printed using ABS on a Stratys Fortus 250 mc to enable the use of water-soluble support structures to accommodate the large overhang from the window cutout in the front of the scaffold. The inventors also constructed a waterproof cathode using a combination of 30% wetproofed carbon cloth from Fuel Cell Store, carbon felt, room-temperature-vulcanizing silicone, and a custom 316 stainless steel flange so water could not enter the chamber through its side. The screws (McMaster-Carr 90666A131) and nuts (McMaster-Carr 93935A335) used were made of 316 stainless steel, as well. Three replicates of these v3 cells were placed side by side with three v0 control cells identical to the setup described above.

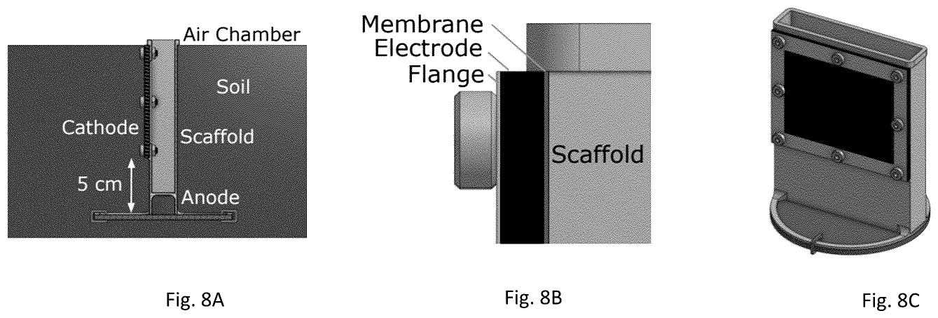

FIG. 8 shows the v3 design with a sealed air chamber cell design to prevent the cathode from being submerged during flooded periods. Specifically, FIG. 8A depicts the air cathode, soil, anode, ABS scaffold, and air chamber sealed against the soil environment on the cathode side, only exposing one face of the cathode to air in accordance with an illustrative embodiment. As shown, the top remains open to enable oxygen entry. FIG. 8B depicts the 316 stainless steel flange, carbon felt electrode, 30% wetproofed carbon cloth membrane, and ABS scaffold of the v3 design in accordance with an illustrative embodiment. FIG. 8C depicts an isometric view of the assembly in accordance with an illustrative embodiment. A METER ECH2O EC-5 soil moisture sensor was used to log the soil's VWC over time. The v3 cells showed significant improvements over v2 in this experiment.

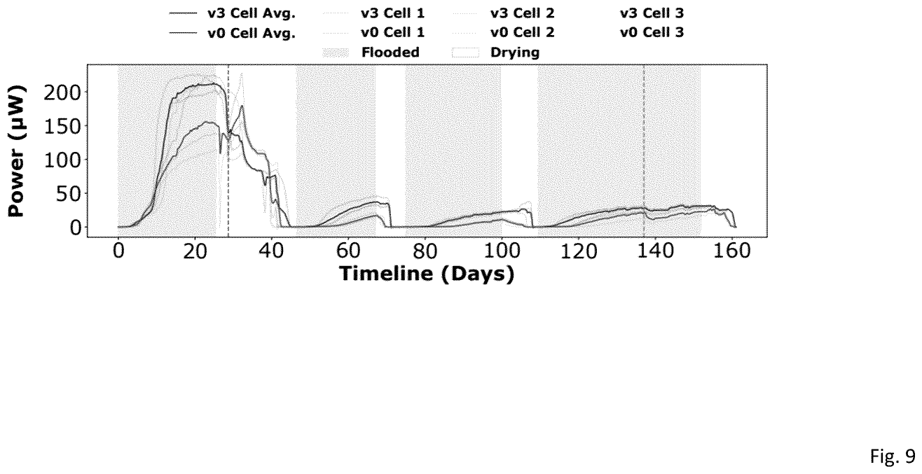

FIG. 9 depicts power from v3 cells vs. v0 cells across four moisture cycles in accordance with an illustrative embodiment. The v3 design outperformed the v0 benchmark throughout nearly the entire experiment, featuring better power output during flooded periods and faster recovery from droughts. The SMFCs' power was the highest during the first moisture cycle and remained relatively the same in subsequent cycles (about 30 μW for v2 cells and 15 μW for v0 cells).

The v3 design no longer has the issue of decreasing power output after being submerged for extended periods like v2, and it also kept the enhanced recovery rate that the v2 cells had after being re-hydrated in the second flooded period. v0 Cell 1 was omitted from the average calculation after day 137 (vertical gray dashed line) due to logging disruptions. The v3 cells outperformed the control cells throughout the entire experiment except for part of the first drying period. This trend of increasing power outputs from v0 during the drying period was most likely a result of experimental error, as it was not seen in the following three drying periods in FIG. 9. The PLA clips that secured the v0 cathodes to their scaffolds broke around day 28 (vertical green dashed line), which required the cathodes to be pushed down into the soil so they could be reattached to the scaffolds. This improved the cathodes' contact with the wet soil underneath, artificially boosting the electrolyte's ability to transport ions. Similar to the results discussed above, the first moisture cycle achieved the highest power output, with the subsequent cycles stabilizing to a lower level. This behavior is likely an artifact of our soil preparation process, which includes completely air-drying all of the raw soil so it can be sieved and homogenized prior to installing the SMFCs.

Rewetting dry soil can cause a burst in biologically available carbon, which has been observed to correlate with a sudden surge in CO₂ production in what is known as the Birch effect. This effect is exacerbated by extreme swings in soil water content and mixing of the soil, both of which were part of our experimental procedure. This, combined with the stable outputs in subsequent moisture cycles, indicates that the initial power decrease doesn't signal SMFCs depleting their organic carbon source. In fact, there was no appreciable decrease in total organic carbon (TOC) between the soils surrounding the cell anodes and the bulk soil even after months of operation. In natural environments, TOC is replenished by plants and animal activities, and it is believed this can offset the minute carbon consumption of SMFCs and keep them operating indefinitely. This suggests that SMFCs can keep producing power given sufficient moisture from the environment.

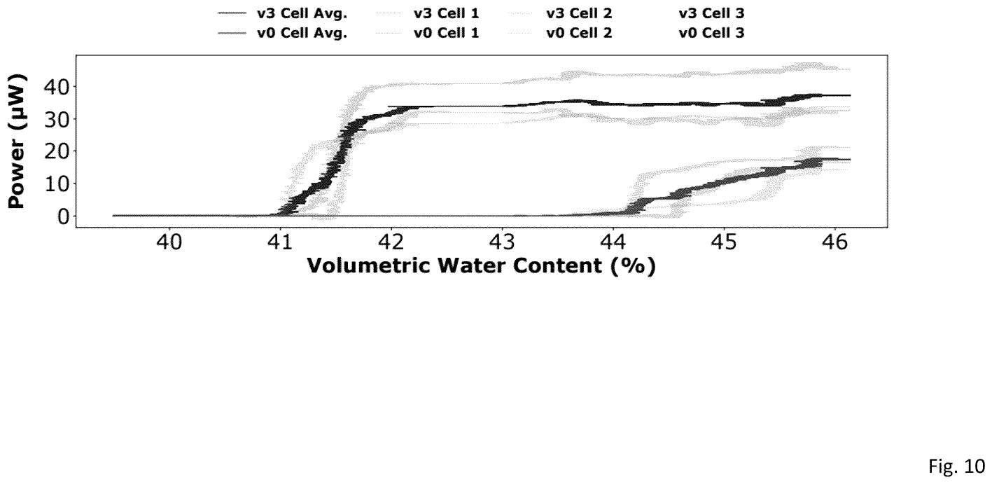

FIG. 10 depicts power output comparison of v0 and v3 cells as a function of VWC during the second drying period, where the v3 cells were able to perform at a 4% lower VWC, making them more robust to lower soil moisture levels in accordance with an illustrative embodiment. As shown, while the average v0 cell output dropped linearly to 0 μW between VWC of 46% and 44%, the v3 cell power seemed unaffected by VWC until it decreased down to the 42% mark. This means that v3 cells were more robust to changes in surrounding moisture contents, making them more suitable for power generation purposes. This 4% improvement in functional VWC range, though limited, is significant considering this is the first example of altering SMFC design to improve their robustness to soil moisture content.

The high VWC value in the experiment (>40%) likely means that even the v3 SMFCs would not do well in the comparatively drier agricultural soils. However, many grasslands and marshes have soil moisture levels hovering around 40-50%, making lowering the minimum VWC requirement for SMFCs in this range critical for many environmental monitoring applications. It is interesting to note the steep slope of v3 cells' power decline. This aligns with prior work that hypothesized how air invasion in the electrolyte soil layer leads to the discontinuity of its liquid phase, hindering the ion transport between the electrodes and stopping power production abruptly. This suggests that future efforts with SMFC iteration should explore re-designing the electrolyte so that its ion exchange capability can be independent of its moisture content. The implications of v3 cells' increased functional VWC range on computing is further explored below.

Although the v3 cells made drastic improvements over previous iterations in terms of power output and robustness, there are still items that should be addressed to improve the practicality of the design. Because the anode of the v3 cell was made identical to the v0 anodes to eliminate variables, the base of the cell ended up being much wider than the top, making insertion into soil difficult. Furthermore, the thin PLA ring that the anode disk gets clipped to is prone to breaking when the cell gets dug out, reducing the reusability of these devices. The material selected for the prototype also did not create a tight enough seal in the cathode air chamber, and water was able to infiltrate in small amounts into Cell 2 and 3's air chambers after 2 months. The water was manually removed with a pipette during the experiment to avoid submerging the cathodes, which would not be feasible for autonomous deployments. In addition to improving the quality of the seal, a real cell deployed outdoors would need to be modified to prevent rain from entering the top while still allowing airflow. These issues were resolved by the use of a thicker, more monolithic scaffold composed of plant-based PLA plastic.

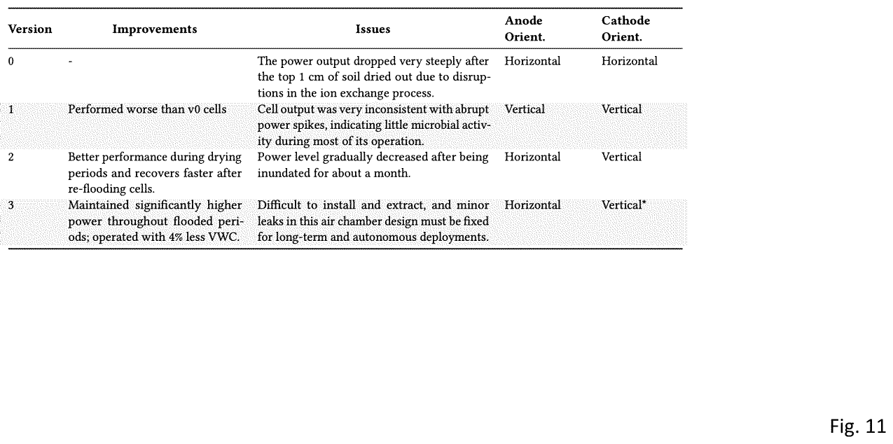

The experiments optimized SMFCs' ability to power computing devices by changing the relative orientations of their electrodes. This made the cell more robust to changes in VWC and produce higher power overall, which makes it a more stable power source for low power electronics. The v0-v2 cells had a number of shortcomings that were addressed by their respective successors, which led to the conception of the improved v3 design. FIG. 11 depicts a summary of the key design issues and improvements in accordance with an illustrative embodiment. The device can be further improved by adopting a solid-state electrolyte that performs independently of moisture content and adjusting the form of the cell to integrate the electronic components necessary for wireless sensing.

From the data and observations gathered throughout the design iteration process, the inventors extracted a debugging framework to systematically test and improve SMFC performance. The inventors also compiled a list of common issues in setting up SMFC experiments and how to address them. The framework uses reference electrodes and external sensors to identify whether the bottleneck to achieving higher power lies in the anode or cathode of the SMFC. This method evaluates cells based on their relative performances and can serve as a powerful tool for future researchers to optimize SMFCs for their desired purpose. Since each SMFC experiment can take months to conduct, sharing methods and learnings will help future SMFC researchers shorten their design cycles and accelerate the field of soil-powered computing as a whole.

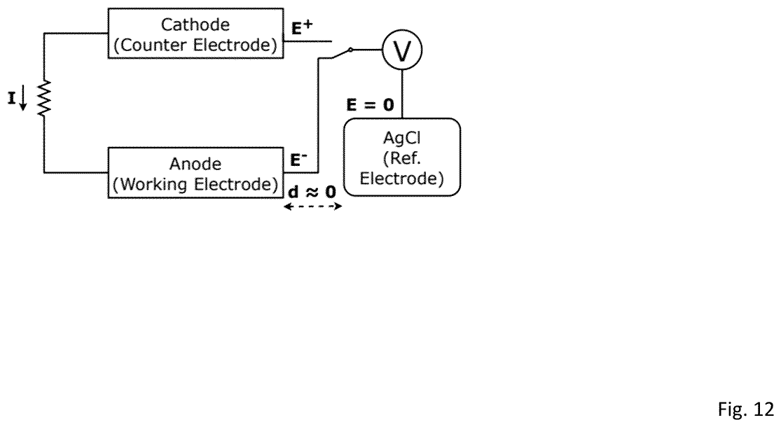

Because there are so many factors that could affect the performance of SMFCs, it was found to be imperative to compartmentalize cell designs into modules that can be improved individually. One of the most effective tools used to identify issues in the cells is the reference electrode. In existing studies on the behaviors of aqueous MFCs, there are 3-electrode cell architectures featuring a working electrode (the biotic anode), counter electrode (the abiotic cathode), and an additional reference electrode (typically AgCl). Although this configuration is typically used with a potentiostat to perform advanced analyses like cyclic voltammetry, the inventors instead leveraged it to evaluate the SMFC's anode and cathode potentials separately. FIG. 12 is a schematic of the 3-electrode SMFC configuration to measure anode and cathode potentials relative to the reference electrode (E and E⁺ respectively) in accordance with an illustrative embodiment. The reference electrode should be placed as close as possible to the electrode one is measuring to avoid uncompensated ohmic drop, which can skew the voltage measurement.

As stated above, the total output voltage from a SMFC is the difference between the potentials from the anode and cathode half-reactions. Therefore having insights into which half-reaction is underperforming will allow one to make specific changes that target the electrode in question. Once it was understood which electrode performance is the limiting factor, the inventors were able to make more informed decisions regarding sensor selection and experimental design to identify precisely why that electrode was behaving poorly. For example, it was observed that E⁺ was poor while E looks normal, so the inventors did not invest resources into sampling the biofilms in the soil or install an oxygen sensor to monitor O₂ penetration into the soil since neither of those affects the cathode performance. A significant challenge in this methodology, however, is determining what a “poor” E⁺ or E actually is.

Although the theoretical standard potentials of the anode and cathode half reactions are known to be −0.29 V and 0.81 V relative to a standard H₂ electrode (SHE) respectively (or −0.49 V and 0.61 V relative to a AgCl electrode because the AgCl electrode potential relative to SHE is 0.197 V), these numbers are calculated using just acetate as the substrate and do not take into account the vast diversity in the types of organic carbons exoelectrogens oxidize in the soil. A number of other external factors make comparing measured E and E⁺ to an absolute standard impractical since the measured values will always deviate from their theoretical counterpart just due to effects from these environmental conditions.

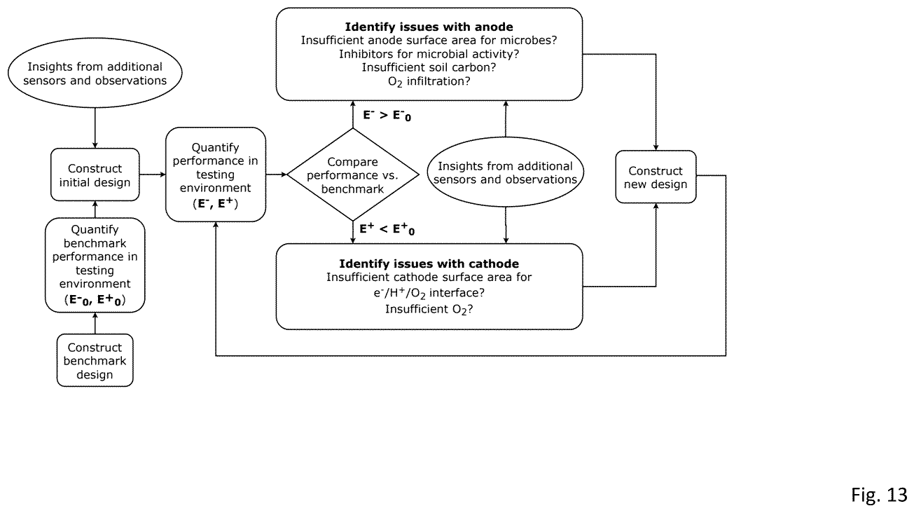

As such, the better approach was found to be comparing the measured E and E⁺ values of a designed cell to their corresponding values from a benchmark cell in the same environment. These relative comparisons can then be used with additional sensor data (temperature, moisture, pH, O₂, etc.) and insights from SMFC theory to identify issues in the design and improve upon them. FIG. 13 depicts a suggested framework for identifying weaknesses in SMFC design and iteratively improving the SMFC in accordance with an illustrative embodiment. This framework was used to evaluate the measured potentials to identify issues in anode and cathode performances respectively. The inventors selected a Mudwatt-based design (v0) as the initial benchmark due to its widespread use in existing literature and simple construction. The inventors periodically spot-checked electrode potentials using AgCl reference electrodes instead of permanently burying them for continuous measurements since they are ruined easily by membrane fouling and drying in soil. Using reference electrode readings combined with a VWC sensor and visual observations lets one systematically identify design bottlenecks and target an approach on the two electrodes accordingly. This framework can speed up SMFC's design process, which is vital to developing soil-powered ubiquitous computing.

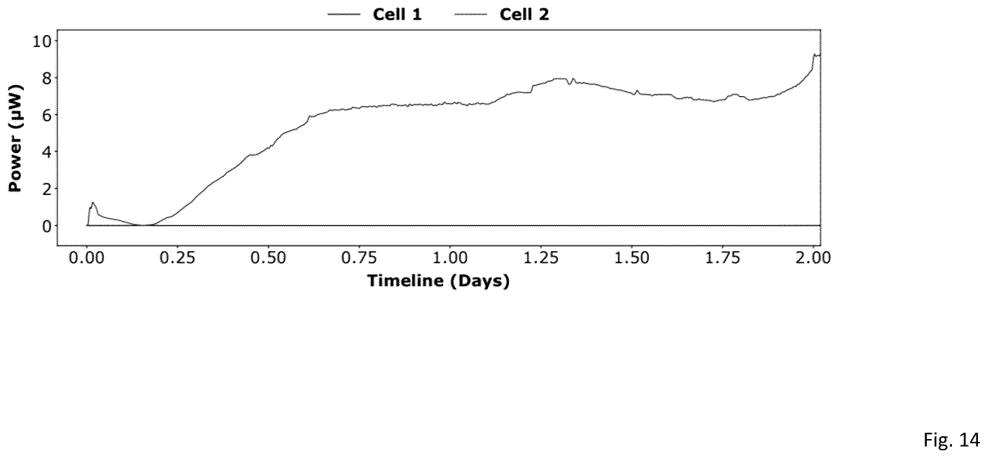

To inform future researchers of potential pitfalls in SMFC experiments, the inventors listed some of the common issues and their respective solutions from the 2-year-long prototyping and design iteration experience. For example, large variability in cell performance is addressed. FIG. 14 depicts that soil texture variation can vastly affect cell performance in accordance with an illustrative embodiment. Prior to setting up the v0 experiments, large variations in the behaviors of different cells were experienced due to local differences in soil texture caused by the presence of rocks and branches. This can make experiments very difficult to replicate and result in theoretically identical cells producing vastly different outputs in the same environment. To resolve this, the inventors thoroughly sieved the raw soil used for all of the experiments so they are all within the same range of soil texture and particle size. The inventors also wetted the soil into a slurry and mixed it extensively to make it more homogenous prior to embedding the SMFC, since dry soil will naturally separate out by particle size due to granular convection, causing variations in soil texture at different depths.

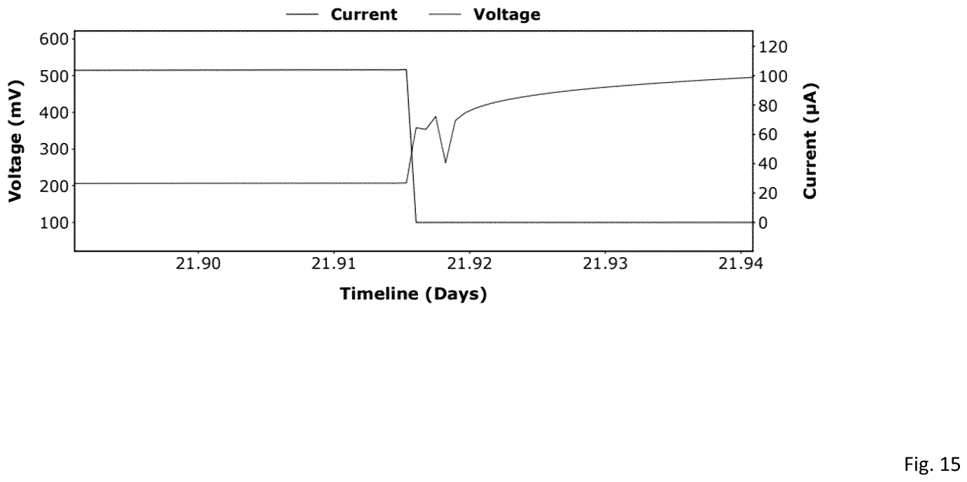

Because SMFCs are buried in soil, mud and water may get between the carbon felt electrode and the wire connecting it to the external circuit. As such, if the wire is not properly secured to the felt, the connection between the wire and the felt may break, sharply reducing the voltage of the SMFC despite no sudden environmental change. FIG. 15 depicts how a poor connection between the load circuit and the carbon felt electrode can result in increasing voltage, which throws off the power measurement in accordance with an illustrative embodiment. To resolve this, the inventors made sure to weave at least 3 inches of clean titanium wire into the felt prior to burying the cells, and installed external strain relief to avoid accidentally ripping out wires from their respective electrodes. The inventors also probed the exposed end of each wire and the far side of its corresponding electrode using a multimeter to test for continuity prior to burying the cells.

There have also been observed instances of SMFCs only going up to 10-20 μW after weeks of incubation despite an abundance of water. This may have a number of causes ranging from low microbial activity or diversity to the soil directly touching the cells not having sufficient organic carbon. While the exact causes are not always known, digging up the cells, thoroughly remixing the soil with a lot of water, then reburying them usually resolves the issue. If doing this a couple of times still does not allow the cells to climb to the >100 μW range while connected to 2 kΩ resistors, then one can try re-incubating in a different soil.

Additionally, since SMFCs react to VWC changes on such a local scale (just the top few cm of soil around the cell), it is difficult to correctly capture this change with conventional equipment. Most commercial VWC sensors have relatively large measurement volumes, making them ineffective at capturing the VWC changes that affect SMFC power. To ensure that relevant trends in VWC are sufficiently captured in SMFC experiments, one should choose sensors with as small of a measurement volume as possible and install them at the same height in the soil column as the SMFC cathode. One should also eliminate any large particle or air pocket near the sensor if a capacitive VWC sensor is used to avoid lowering its sensitivity.

To further gauge the feasibility of soil-powered sensing systems given the limitations of current SMFCs, the inventors conducted a number of evaluations using the data and prototypes discussed herein. A computing runtime simulation was performed in which simulated runtime for different computing modalities was performed using real world SMFC voltage traces from the design iterations, contextualizing the performance impacts of the redesigned v3 cell with improved energy production. An outdoor evaluation was conducted, in which the inventors deployed a modified v3 SMFC (v3.1) in realistic outdoor conditions and analyzed its performances alongside soil moisture data to determine if it can achieve useful power levels in the field. Soil-powered backscatter sensor demonstrations were also conducted. The inventors integrated SMFCs with low-power analog backscatter sensors, known as MARS tags, for touch and soil moisture sensing, showcasing the potential of soil-powered wireless sensors.

The inventors conducted a computing runtime simulation to simulate the theoretical number of operations one could achieve with the v3 cell design compared to the control v0 cell. The inventors built the simulation using real-world SMFC voltage traces collected throughout the design iterations (161 total days of data collection) alongside datasheet values for three computing modalities. This simulation serves to demonstrate how much improving SMFC's robustness (even just by a little bit) matters for computing by benchmarking the number of theoretical operations one could execute given different SMFCs' power levels. Specifically, answers to the following questions were sought: (Q1) What comparative performance can one expect for SMFC-powered computing across a range of devices?(Q2) What is the computing performance impact of the re-designed cell with more stable energy production?

The simulation presented below lets one explore these questions repeatably while relying on actual, real voltage traces collected from the cells. The simulator replays the voltage and current traces of real-world SMFCs, yet it does not model the SMFC itself nor the various environmental parameter's impact on the cell. Instead, this trace-based simulator allows one to compare SMFCs in different environments, or different SMFC designs, merely by capturing a few traces of their output. This evaluation contributes by comparing performance and operation to better understand how the proposed system enables novel computing applications powered by soil.

The inventors investigated the SMFCs as power sources for two traditional and one emerging computing paradigms. Advanced, high-capability systems are edge devices with more advanced sensing, computing, and communicating tasks. These devices often heavily rely on checkpointing and other intermittent computing elements to accomplish tasks over time. As a representative example, the analysis considers the LoRa-based system, as such long-range communication capability will likely be important to many SMFC deployment scenarios. Minimal digital systems are minimalist edge devices that attempt to use as little energy as possible to do something useful. The quintessential example is the “Monjolo”-style sensor, which only boots and sends empty packets (the rate of packet transmission is the sensed signal). As a representative example, one can consider the Cinamin beacon, which solely attempts to send BLE advertisement packets. Analog systems are an emerging class of novel devices implanted as “computational materials”, systems of even-lower power, which save power by omitting digital logic and leveraging passive or semi-passive communication techniques to enable sensing on record-low energy budgets. As a representative example, one can consider the MARS tag, which is a purely analog, backscatter-enabled, ultra-low power, and inexpensive sensing device. As MARS reported numerous performance specifications, the inventors use this work as a stand-in for the wide variety of analog backscatter-enabled sensing work.

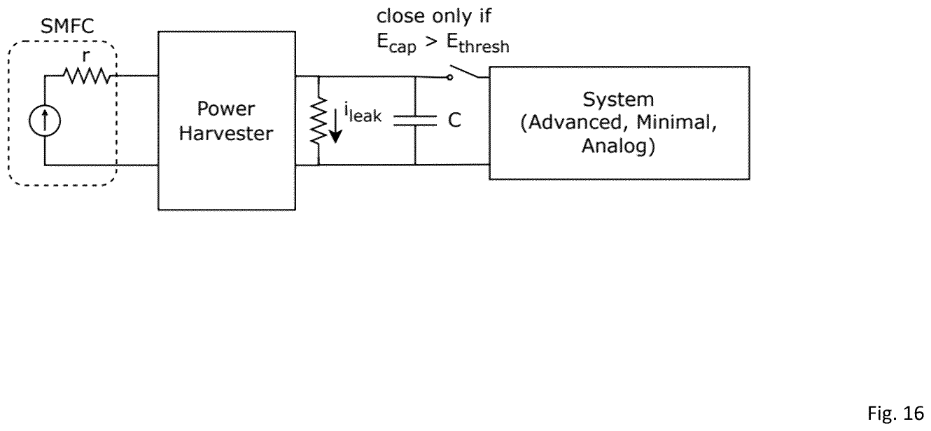

To account for the fact that microcontrollers and peripherals such as the Dialog DA14581 and Murata CMWX1ZZABZ-078 require higher operating voltages and bursts of instantaneous power that exceed the roughly 200 μW produced by the SMFCs, the inventors assume that all three system types receive energy through a power harvester circuit that charges a storage capacitor from either a single v0 or v3 SMFC cell's output. FIG. 16 depicts a schematic of a simulated setup in which the SMFC is the Energy Source, the harvester, storage capacitor C, and switch are the Energy Buffer and Charge Controller, while the Energy Consumer varies based on the application in accordance with an illustrative embodiment. The inventors used a fixed charge controller but explored how the Energy Buffer varies with application. In the simulation, the power harvester opens the switch when E_{cap} is below Eₜₕᵣₑₛₕ. This architecture is similar to most battery-free and intermittently powered sensing literature. A simulation environment similar to previous research on predicting the performance of energy harvesting computing was used, given the highly dynamic and unpredictable nature of energy harvesting in the field.

The average voltages across all v0 and v3 cells are similar, so the inventors took the average of all the voltage traces and used them to calculate the expected energy accumulated on the storage capacitor. While numerous circuit models exist for aqueous MFCs, little has been done to model the behavior of soil-based MFCs. To date, the best-known model treats the SMFC as a constant current source with complex dynamics under AC loads. These dynamics are ones a cell may be subjected to by a switching boost regulator in a harvester IC. The longitudinal sampling of cells from our experiments subjected the cells to a fixed DC load of 2 kΩ. The measurement setup recorded cell voltage under this load every sixty seconds. An MFC-aware harvester should be able to match or exceed the power extracted from the cell with a static load. Therefore, there is assumed to be constant power output from the MFC between each sampling timestep to simplify the modeling. In the absence of any MFC-optimized harvester ICs, one can turn to the Analog ADP5091 instead, which was previously used in SMFC systems and is designed to work with low-voltage sources. It is roughly 60-80% efficient over the range of voltages that SMFCs can generate. In each timestep, the efficiency of regulator at the current SMFC output voltage. 77ADP represents the percent efficiency of the ADP5091 harvester given an input power from the SMFC. There is assumed to be no loss charging the capacitor, however, one must account for the leakage of the storage capacitor, as even low-leakage tantalum capacitors common in energy harvesting designs have losses significant to application behavior. Using a KEMET T491 as a reasonable representative measure, the storage capacitor leakage current is expected to be iₗₑₐₖ=0.01×C×V_{capt} μA. Putting all this together, the final model for the energy in the storage capacitor over time (not yet accounting for energy consumed by the system load for the application) at step n+1, or E_{captn+1}, is:

$${E}_{captn + 1} = {E}_{captn} + {V}^{{2}_{SMFCn}} / 2 k Ω \times {η}_{A D P} \times {t}_{step} - 0.01 \times {10}^{- 6} \times {E}_{captn} \times {t}_{step} \qquad Equation 4$$

In Equation 4, the term V²_{SMFCn}/2 kΩ represents power from the SMFC, the term V²_{SMFCn}/2 kΩ×η_{ADP}×tₛₜₑₚ represents J added to the storage capacitor, and the term 0.01×10⁻⁶×E_{captn}×tₛₜₑₚ represents J leaked during a timestep. E_{captn} is the energy in the capacitor from the previous time step. For each of the three system types, one can define a threshold energy Eₜₕᵣₑₛₕ at which the system will power the load and the capacitor will discharge to perform a discrete operation. Opportunistic operation on discrete energy quanta is a common paradigm for a diverse array of energy harvesting systems. Upon completion, the capacitor will start accumulating energy until it builds up enough energy to turn on the system again (e.g., when E_{cap}>Eₜₕᵣₑₛₕ in FIG. 16). Some key factors were identified that influence this Eₜₕᵣₑₛₕ value, such as the minimum operating voltage of the device (Vₘᵢₙ), the peak active current draw (Iₚₑₐₖ), the total energy used per event (Eₑᵥₑₙₜ), the amount of time required to perform the operation (t_{active}), and (when operating intermittently) the startup time (tₛₜₐᵣₜᵤₚ).

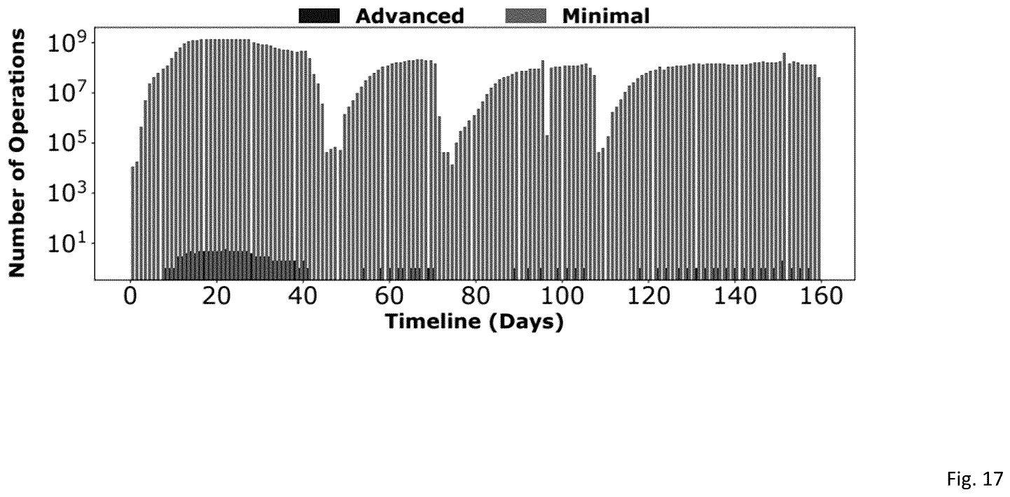

The inventors used the simulation framework to explore the performance of each system, running all three devices in our trace-driven simulator across 161 days of continuous data. FIG. 17 illustrates the daily number of discrete events the intermittent devices could complete given the energy input from the v3 SMFCs in accordance with an illustrative embodiment. The number of operations each system executed is linked to the health of the SMFC, and sharp drops in the number of operations can be associated with the drying periods. Regardless, the power output from a single v3 cell is enough to activate a wide range of devices for a significant portion of time while the surrounding moisture level is sufficiently high. Due to the low power requirement of MARS, it is able to sustain continuous operation during the majority of the 161-day simulation.

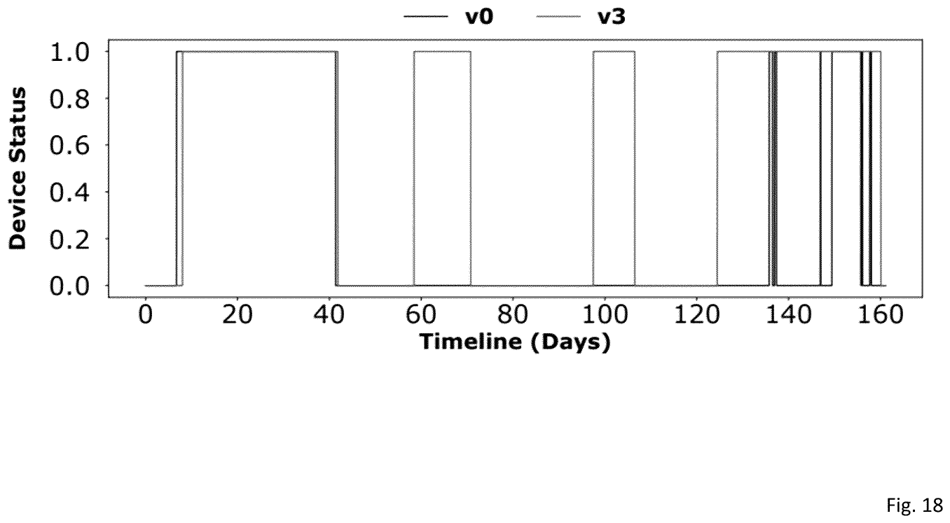

FIG. 18 examines how often MARS would run assuming it was directly powered by the SMFC with no harvesting or storage in accordance with an illustrative embodiment. The inventors calculate this by finding the total energy produced over the 161-day experiment and using that to estimate the average power generation. For v3 and v0, the average power generation is 26.5 μW and 14.7 μW respectively, which is well above the 0.385 μW required to keep MARS continuously powered assuming an ideally-sized and adaptive capacitor (i.e., no energy is lost and events run as soon as enough energy is available). The energy use of MARS is so low that once it turns on, it could stay on forever. This means that sufficient energy could theoretically be accumulated to weather all of the harvesting droughts through the use of storage capacitors. In fact, the v3 cell generated on average 68 times more power than needed for the MARS tag to operate, and increased its theoretical runtime by 120% compared to the baseline v0 cell in FIG. 18.

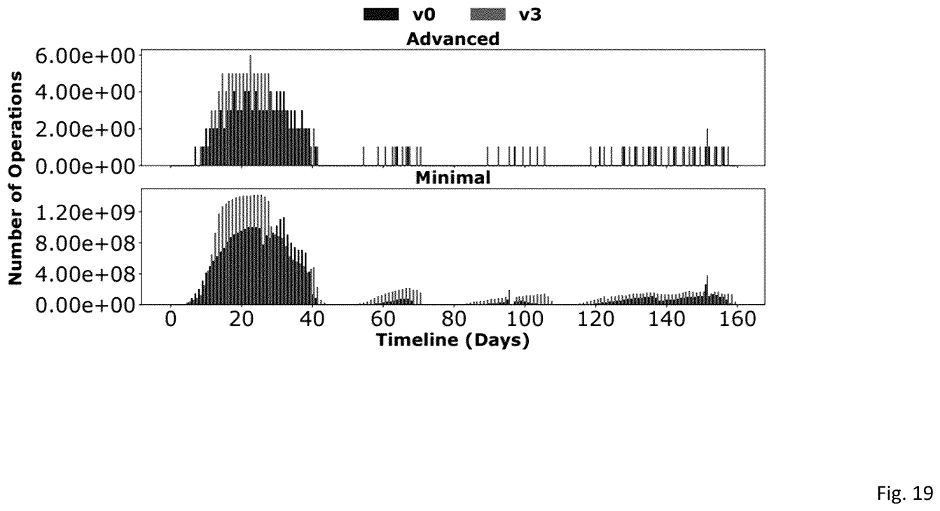

This raises the question of what more sophisticated function or circuitry might be supported on an analog backscatter computational material, or if multiple MARS tags with redundant or complementary sensor load-outs could be powered by a single MFC tag and fanned around a small area to increase spatial resolution and signal fidelity. This incredibly low-power operating point is highly useful for measuring volatile and dynamic data streams that benefit from continuous sensing, which would not be possible with the other computing paradigms. However, its simple nature means that it is restricted to wirelessly delivering a constant stream of data. On the other hand, microcontroller-based systems are capable of much more complex and flexible, context-sensitive operations. When compared to the systems powered by the baseline v0 cell, systems powered by v3 cells are able to achieve a roughly 40% increase in total operation count across the board (43.2% for Advanced and 41.7% for Minimal), further contextualizing the new SMFC design's improved robustness to VWC. FIG. 19 depicts the daily number of operations from minimal and advanced configurations powered by a v0 or v3 cell in accordance with an illustrative embodiment. Although the v3 cell's increased operating range is only 4% from a VWC standpoint, this translates to a considerable increase in the amount of computing the design enables. The difference in the number of operations achieved is especially significant after the first drying period since v3 cells feature a better recovery rate and are more robust to changes in VWC. Further, there is a large discrepancy between the number of achievable operations between the minimal and advanced configurations. Since the number of operations is so low for the advanced setup due to its high energy cost, the difference between the v0 and v3 cell performances became less obvious.

From the results obtained in this simulation, it was concluded that the new v3 cell design is more suitable for computing due to its ability to achieve an over 40% boost in the number of operations each digital system (i.e., advanced and minimal) can execute while giving the Analog system a 120% increase in runtime. The inventors also determined that analog backscatter-based systems (i.e., MARS) offer the most reliable theoretical performance among the systems benchmarked in terms of computational availability because a SMFC can often exceed the computational device's energy demand. While MARS requires orders of magnitude less energy than even the lowest-power microcontroller, it is restricted to just sending a steady data stream (via backscatter with a monostatic sensing range of 12 m on a 20 kHz bandwidth) and cannot handle advanced computations the way a digital device can. However, given the low and intermittent nature of SMFC's power output, the additional capabilities provided by more energy-intensive systems could be over-provisioned for distributed sensing purposes, and have low utility in the field due to missed sensor readings.

Although the v3 cells have been shown to produce upwards of 50 μW after being dried out, they were evaluated under controlled settings where the soil was kept flooded for weeks at a time to revive them back to their maximum output after each drying cycle, which is unrealistic for most applications. To examine the improved v3 SMFC under field conditions, one can deploy a modified v3 cell (v3.1) outside in an irrigated yard to gauge its performance and understand the impacts of real-world stimuli on SMFC power output.

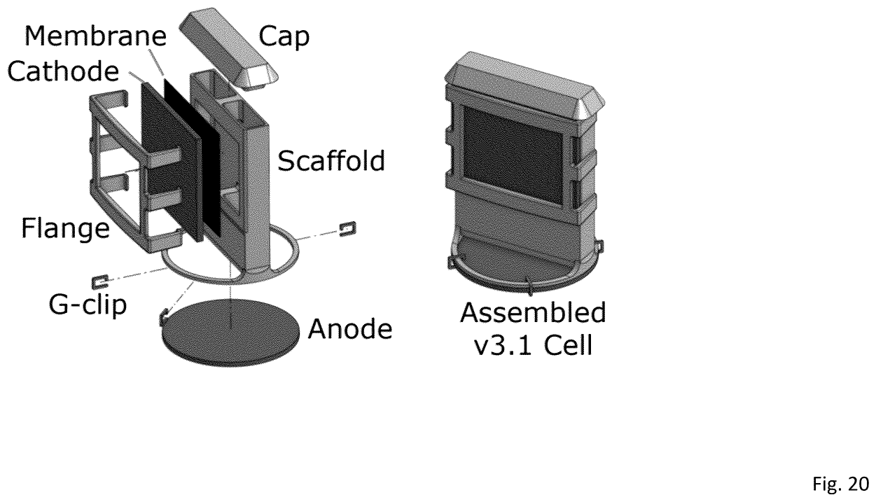

Prior to setting up the experiment, the inventors modified the v3 cell design to address some of the mechanical issues it faced in lab deployments, namely leakage into the air chamber and the scaffold breaking during installation/extraction. FIG. 20 depicts exploded and assembled views of the v3.1 SMFC modified from v3 cells to make it leak-proof and improve its mechanical strength for outdoor deployment in accordance with an illustrative embodiment. All of the electrode geometry and configuration were kept the same to ensure minimal impact on cell behavior. The stainless steel flange and fasteners were replaced with a monolithic 3D-printed snap-fit flange, and the scaffold was also bolstered with additional fillets and supports to increase its strength and decrease the number of openings for water to infiltrate through. A cap was added to the top of the scaffold to prevent rainwater and debris from entering the air chamber while still allowing for airflow. The scaffold, flange, cap, and anode G-clips were all 3D printed from plant-based PLA plastic to reduce the number of store-bought parts. In alternative embodiments, different material(s) may be used to form the system components. All of the membrane and electrode materials, geometries, and configurations were kept the same as the v3 design, ensuring minimal impact on cell behavior.

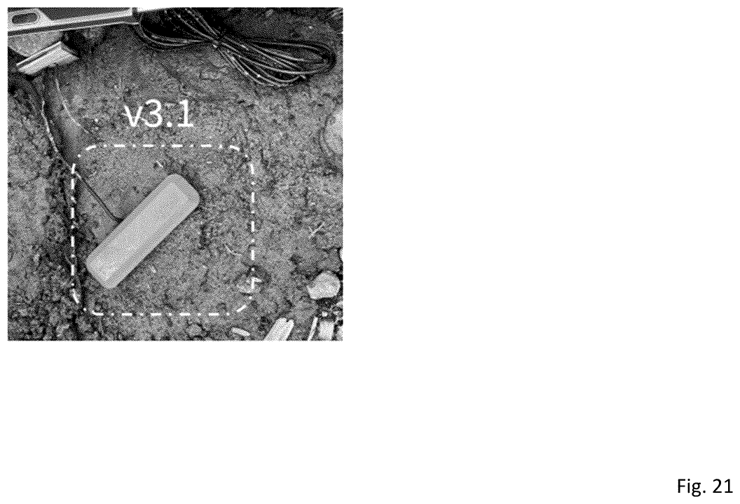

One can refer to this mechanically more robust version of the v3 cell as v3.1 herein. The deployment site for this experiment is a residential yard at a location with hot-summer Mediterranean climate. The surrounding environment is highly arid, with all of the non-desert plants being regularly irrigated to keep them alive. This location was chosen to observe the effects of irrigation (or the lack thereof) on SMFCs in naturally dry environments, which has been a highly-motivating application for smart agricultural sensors. To jump-start the experiment, the inventors first incubated the v3.1 cell under inundated conditions in the lab with soil collected from the deployment site until the cell reached a steady-state voltage of about 600 mV, which was approximately the maximum of what the v3 SMFCs achieved in earlier experiments. The cell was loaded with a 2 kΩ resistor during incubation and throughout the entire deployment. After incubation, the v3.1 cell was installed at the deployment site under the shade of a potted pygmy date palm (Phoenix roebelenii). It was carefully placed into a hole with its incubation soil intact to reduce disruptions to the anode biofilm. Otherwise, the cell was kept in an open environment with no external barrier underground. FIG. 21 is a top view of the v3.1 cell buried outside in an irrigated residential yard in accordance with an illustrative embodiment. The v3.1 cell is covered with a 3D-printed cap that prevents debris from entering while allowing for airflow. The cell was irrigated through both drip irrigation and manual watering depending on the need of the tree. The soil moisture data was collected with a METER TEROS 12 sensor, while the cell's voltage and current were measured with an INA219 power monitor (Adafruit INA219).

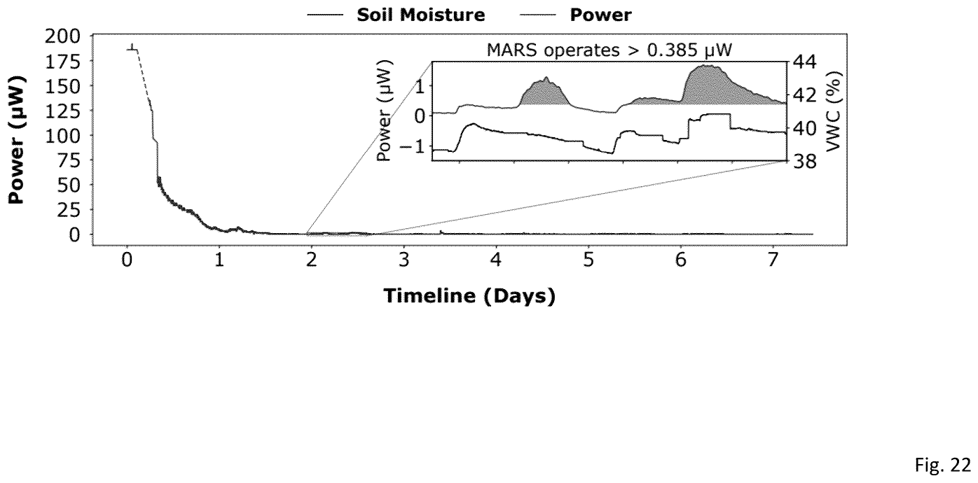

FIG. 22 depicts that the power level of the incubated v3.1 cell dropped significantly after being transplanted outside in accordance with an illustrative embodiment. However, it still produces enough power to theoretically turn on MARS during spikes in moisture levels caused by occasional irrigation (see shaded regions for the energy usable by MARS). This amount of power is also within the envelope of many common subsystems (i.e., a real-time clock) of modern computing, showing promise. The dashed line in FIG. 22 was linearly interpolated to represent the data gap from the time it took to install the SMFC. Within a day of deployment, power decreased from 186 μW to just 4 μW, with a nearly 55 μW drop attributed to the deployment process itself. This is likely a result of oxygen infiltration to the anode when the cell was transported, which caused the anoxic exoelectrogenic biofilm to suffer and the cell potential to drop. However, the cell does not die completely, as its power noticeably increases whenever the VWC spikes after rain or irrigation. It was also observed that the cell produces essentially zero power below 39% VWC, which roughly aligns with the 40-41% cutoff observed in the lab. This slightly lower VWC cutoff may be due to the difference in water holding capacities between the outdoor and lab soils, which affects the amount of water available to organisms at the same VWC.

The v3.1 cell's much lower energy output post-deployment indicates that it would not be sufficient to power the advanced or even minimal digital systems. However, it may still produce sufficient power for certain digital components like real-time clocks (which can function with just 14 nA×1.5 V=21 nW) without accounting for loss from boosting voltage. The v3.1 cell's power regularly jumps up to >1 μW for hours at a time with a maximum of 3.5 μW during spikes in VWC caused by irrigation events, which is also potentially enough for analog backscatter sensors like MARS that require as little as 0.385 μW. This indicates that the v3.1 SMFC can potentially support sensing and computing even under highly irregular moisture variations.

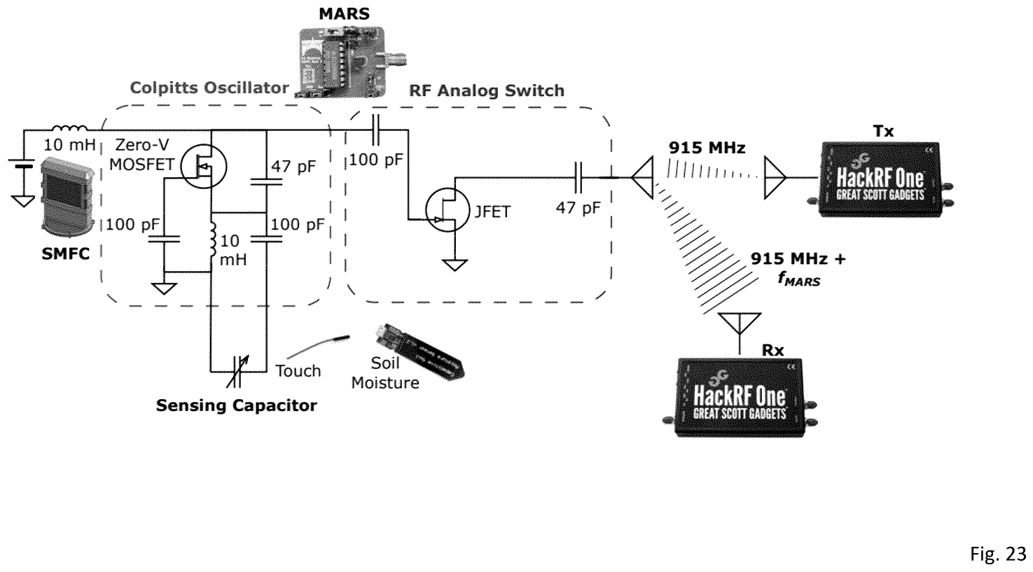

Described below is the potential of soil-powered backscatter sensors by integrating the improved v3.1 SMFC design with MARS tags. The overall system consists of a backscatter sensor and two Software Defined Radios (Great Scott Gadgets HackRF One) for either transmitting the incident wave (Tx) or receiving the backscattered signal (Rx). The backscatter sensor includes a modified Colpitts oscillator tuned to resonate at 200 kHz using a zero threshold MOSFET (ALD110800) as the amplifier. FIG. 23 depicts a SMFC+MARS system diagram in accordance with an illustrative embodiment. The MARS sensor includes a Colpitts oscillator that turns the low DC voltage from the v3.1 SMFC into a higher amplitude AC signal that has a frequency of f_{MARS}, which changes depending on the capacitance of the sensing capacitor. In one embodiment, the sensing capacitor is a simple insulated wire and a large co-planar capacitor made from waterproof PCB. This AC wave goes into the RF analog switch, which connects to an antenna and backscatters the f_{MARs} signal to the Rx HackRF using the 915 MHz incident signal from the Tx HackRF. This backscatter-enabled wireless capacitance sensor is entirely powered by a single SMFC.

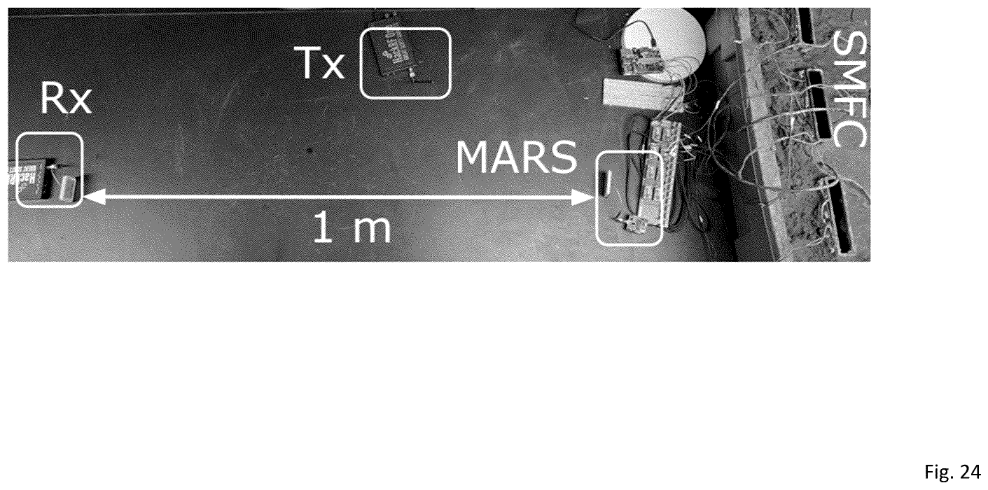

A 200 kHz base oscillation frequency was chosen because it has been well-characterized to work with a sufficiently low startup voltage (110 mV). This oscillation frequency (f_{MARs}) is a function of the capacitance and inductance values in the LC tank circuit. The AC output of the modified Colpitts oscillator is then fed into the gate of a depletion mode N-channel JFET transistor (MPF102), which acts as an RF switch to modulate the backscattered signal. This circuit is powered with a single v3.1 SMFC, and the system can backscatter sensor readings from a 10 dB, 915 MHz incident signal to a radio receiver a meter away. FIG. 24 depicts the backscatter setup including two patch directional antennas on MARS and Rx (Taoglas Limited ISPC.91A.09.0092E) and a monopole antenna on Tx (Great Scott Gadgets ANT500) in accordance with an illustrative embodiment. As noted, the Rx is placed 1 m away from MARS, and this distance can be extended by increasing Tx power or choosing a higher-gain antenna.

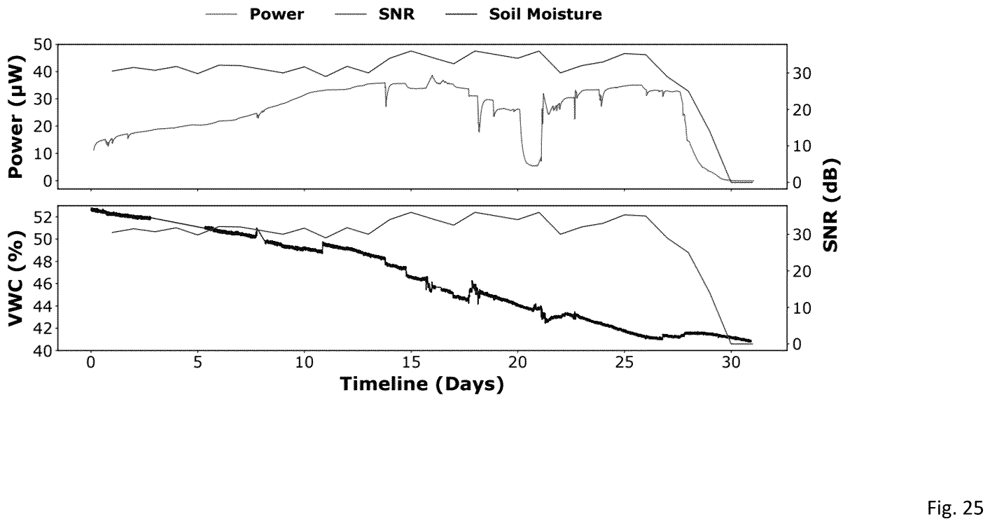

The SMFC was incubated under inundated conditions with the MARS tag as its load until it reached 545 mV before the start of the following experiments. Since a SMFC's power is also a function of its load, the inventors first explore the power behavior of v3.1 SMFC while loaded with MARS alongside MARS' backscatter signal continuity. A previously incubated SMFC cell was used to power a MARS tag while the cell slowly dried, and the backscatter signal was recorded for 31 days. FIG. 25 is a plot of the signal-to-noise ratio (SNR) of the backscattered signal with the corresponding power and VWC measured for the SMFC in accordance with an illustrative embodiment. More specifically, FIG. 25 shows signal-to-noise ratio from MARS' 200 kHz backscatter frequency while being powered by a drying v3.1 SMFC for 30 days. The SMFC initially produced 13.8 μW at 545 mV and 52.7% VWC, and the SNR remained relatively stable throughout the entire drying process until the signal disappeared on day 30 when the SMFC power dropped to 0.781 μW at 179.8 mV and 41.5% VWC. Although this minimum operating output was higher than predicted from Section 5.2, it still falls within the typical 1-1.5 μW that the v3.1 cell produced outside during irrigation, making operating MARS tags possible even in the field.

The backscattered data is pre-processed with a moving average filter and plotted as a spectrogram. Next, the Short-Time Fourier Transform (STFT) strength of the backscattered frequency from the spectrogram is taken as the signal power and subtracted from the average noise floor to calculate the signal-to-noise ratio (SNR). A RocketLogger was used to record the voltage and current of the SMFC throughout the experiment, and VWC was captured with a METER ECH2O E-5 sensor. As observed in FIG. 25, MARS starts backscattering from day 1 with a SNR of 28.5 dB (signal strength=−71.5 dB, noise floor=−102 dB) since the SMFC's initial power (12.8 μW at 545 mV) is well above the MARS startup requirement from literature (0.385 μW at 110 mV). The SNR remains more or less consistent around 30 dB throughout days 1-26 regardless of power fluctuations. On day 27, a fan is installed to accelerate the drying process to observe the point at which backscattering stops. Halfway through day 29, the backscatter signal vanishes below the noise floor. At this time, the voltage of SMFC is 179.8 mV with a current of 4.34 μA (0.781 μW). The discrepancy between the power requirement from the literature and the observed output from the SMFC when MARS turned off may be attributed to the difference between the circuit components used and those used in the MARS paper. This discrepancy was also observed during the MARS tag debugging process, where it would only start operating at 180 mV and above. Regardless, 0.781 μW remains within what the v3.1 cell can produce during outdoor deployment (see FIG. 22), which means a MARS tag can still potentially turn on in the field without any power conditioning circuitry.

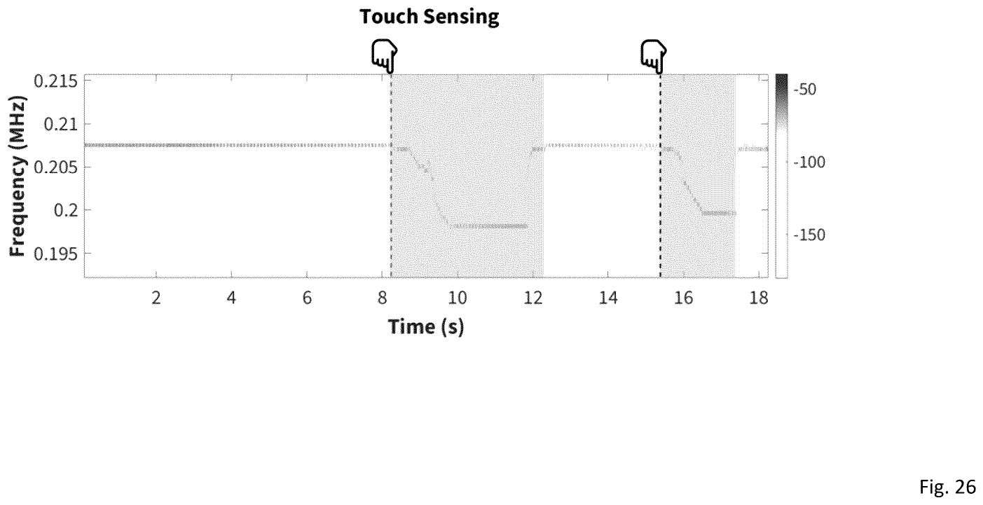

One basic capability of the soil-powered backscatter sensor is touch sensing. As f_{MARS} is dependent on the capacitance of the Colpitts oscillator's LC tank, attaching a simple insulated wire to the device effectively introduces a variable capacitor that acts as a sensor. When the wire is in contact with another object, the capacitance of the wire increases, resulting in a lower f_{MARS} detected by Rx. FIG. 26 depicts results of a user grabbing the sensing wire with their hand twice, which correlates with the two dips in backscatter frequency in accordance with an illustrative embodiment. In FIG. 26, the shaded areas indicate when the sensing wire (a 24 AWG Dupont jumper wire) was touched by a human hand, and the increased capacitance from the hand caused the backscatter frequency to decrease.

Since the fringing field of a cylindrical capacitor (the wire) is very small, only items very close to or directly touching the wire will change its capacitance, making it robust to noise. This configuration provides a binary measurement for whether something is in contact with the wireless sensor, which can be useful for applications like wildlife monitoring. By placing such a device flush with the forest floor, one may be able to create a low-profile soil-powered sensor that perpetually operates to detect whether it has been stepped on by animals. Although solar-powered sensors will perform poorly under dense tree canopies and potential overhead debris, SMFCs require no light and can continue to operate as long as the cathode is not completely buried.

Another practical application of this variable capacitor is soil moisture sensing. To detect changes in the VWC, one can adopt a coplanar capacitor that extends into the bulk soil as the sensing capacitor. The co-planar capacitor is built by modifying a commercial capacitive soil moisture sensor (DFROBOT SEN0193) so that one of its insulated copper plates connects directly to the LC tank and the other connects to the ground of the MARS tag. When the surrounding VWC changes, the absolute dielectric permittivity of the soil also changes, which affects the capacitance value of the sensing capacitor. This change in C shifts the frequency of the Colpitts oscillator, essentially encoding the soil moisture content into a frequency value.

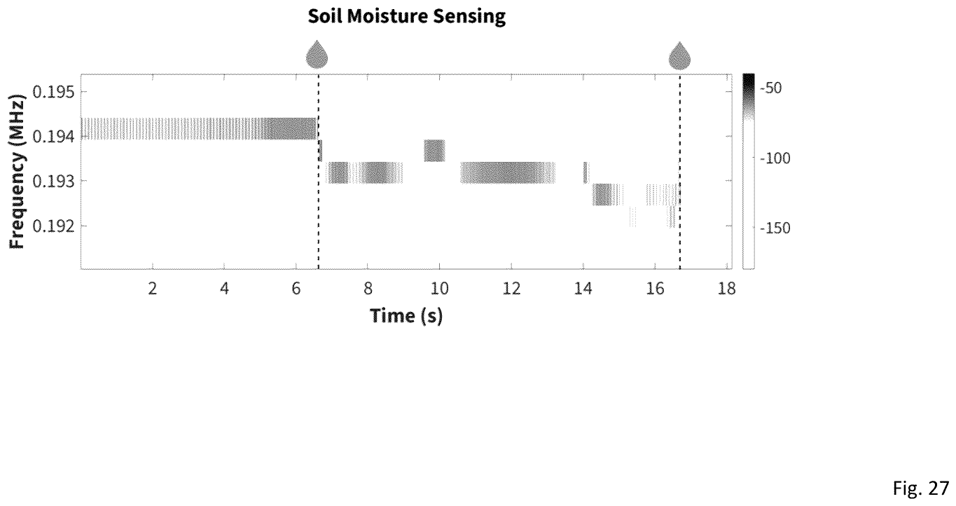

FIG. 27 depicts results of soil moisture sensing with MARS powered by a v3.1 SMFC in accordance with an illustrative embodiment. The soil VWC was increased during each watering event. The backscatter frequency changed steadily from 0.194 MHz to 0.192 MHz in the first watering event due to the increasing capacitance of the sensor, and the capacitance exceeded the upper threshold required for the Colpitts oscillator to oscillate during the second watering event, which caused the backscatter signal to disappear.

In FIG. 27, the moisture sensor connected to MARS was buried in dry sieved soil. Approximately 2 mL of deionized water was poured on the soil near the sensor during each of the two watering events denoted by the black dashed lines. During the first watering event, the backscatter frequency dropped steadily by 2 kHz, and in the second watering event, the backscatter signal disappeared entirely. This is because the additional capacitance imposed by the sensor to the LC tank exceeded the limit for the Colpitts oscillator to remain stable, which brought f_{MARS} to zero. By tuning the geometry and capacitance of the moisture sensor, one can adjust the resolution of the VWC reading and even set a threshold VWC at which the backscatter signal cuts off, alerting the Rx device of overwatering or extreme rain events. This potentially makes the soil-powered MARS sensor a powerful choice for VWC sensing and flood detection in wetland and green infrastructure monitoring applications where batteries and solar panels face issues from corrosion and chemicals leaching out.

The proof-of-concept systems discussed above demonstrate the viability of using SMFCs to power wireless sensors, especially simple analog backscatter devices like MARS. These analog sensors can run on a single SMFC without any additional power conditioning and bring critical sensing capabilities like touch and water detection into wildlife, agricultural, and green infrastructure monitoring applications where SMFCs may thrive. With the advent of organic transistors and plant-based circuit components, simple two-transistor designs like MARS can potentially be made entirely compostable, which combined with a biomass-based SMFC enables the creation of fully-biodegradable, self-powered wireless environmental sensors. These devices can then be deployed at scale to provide high-quality data without worrying about the impacts of littering the environment with e-waste. Although there are still practical issues that need to be resolved, such as improving backscatter communication range and SMFC power continuity, this soil-powered backscatter system establishes a foundation that holds promise to bring a new level of sustainability to ubiquitous computing.

Described below is how one can build their own v3.1 soil microbial fuel cell (SMFC), which is robust to low soil moisture levels and will produce energy for a long duration, even during dry spells. Also included is a discussion of how to construct the v0 cells. In one embodiment, both of these cells can be built from commercially available, off-the-shelf materials and 3D-printed parts with no advanced tools or processing.

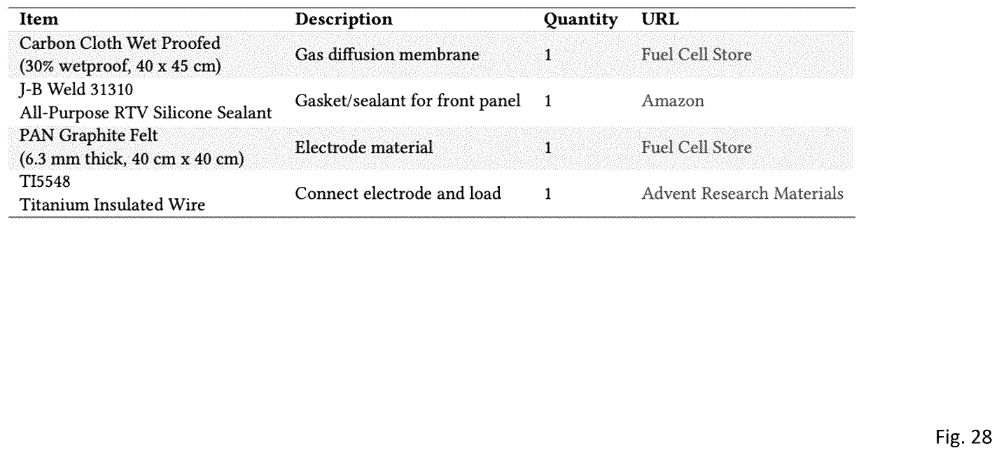

FIG. 28 is a table depicting materials used to construct a soil microbial fuel cell in accordance with an illustrative embodiment. It is noted that each v3.1 SMFC and v0 cell will utilize an approximately 25.4×12.7 cm piece of PAN graphite felt for their two electrodes. Each v3.1 SMFC will also utilize a 10.7×12.5 cm piece of 30% wetproofed carbon cloth. In alternative embodiments, different types and/or sizes of materials may be used.

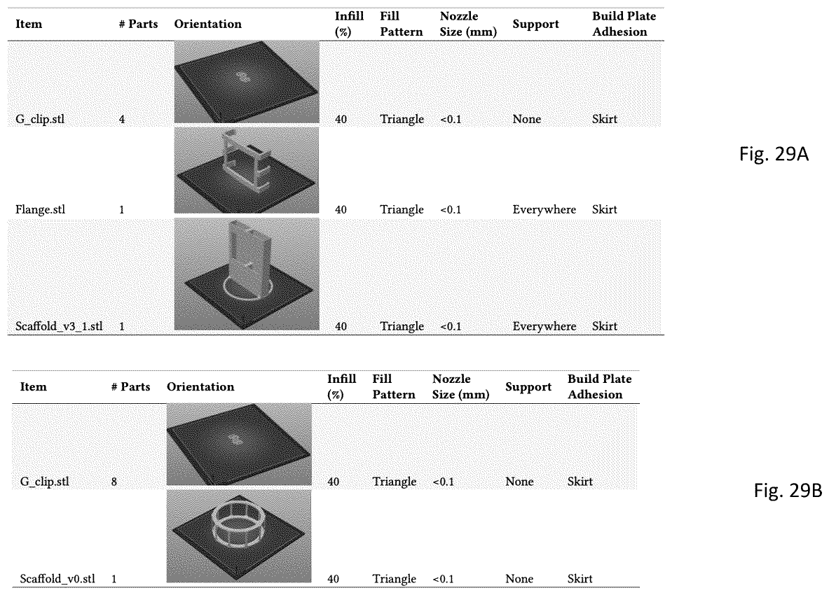

In an illustrative embodiment, components of the SMFC can be 3D printed using files that the inventors have made publicly available. Upon accessing the (.stl) files, a user can load them into a slicing software to generate G-code files for 3D printing. One can print 1 flange, 1 scaffold, and 4 G-clips for each v3.1 SMFC, and 1 scaffold and 8 G-clips for each v0 SMFC. FIG. 29A is a table depicting 3D printing specifications for a v3.1 cell in accordance with an illustrative embodiment. FIG. 29B is a table depicting 3D printing specifications for a v0 cell in accordance with an illustrative embodiment.

To construct a v3.1 SMFC, one should wear gloves prior to working with the PAN graphite felt to avoid skin irritation. Cut 1 piece of 12.7 cm diameter disk from the PAN graphite felt stock using a knife. One can trace the outside of the ring on the scaffold to cut out a round disk that fits very closely. This is the anode. Next, cut out a 10.7×12.5 cm rectangle from the graphite felt stock using the knife and ruler. This is the cathode. Next, cut a 10.7×12.5 cm rectangle out of the 30% wetproofed carbon cloth. This should be the same size as the cathode cut earlier. This is the gas exchange membrane. For construction of a v0 cell, simply cut out the two identical felt disks required for the v0 electrodes.

To assemble a v3.1 cell, one can lay the scaffold down on a table so that the large window opening is facing up. Generously apply an even amount of silicone to the face of the scaffold, especially near the edge of the center window. Place the gas exchange membrane over the window and push it down onto the scaffold. Make sure to line up the bottom of the membrane to the top of the protrusion below the scaffold window. Run a finger over the edges to smooth out the silicone. Place the cathode graphite felt on top of the gas exchange membrane. With both hands, pry the flange legs open just enough to fit them on the side of the scaffold. Line the bottom of the flange up to the bottom of the cathode so that they perfectly overlap, and push the flange into the scaffold until the 6 snap-fit legs lock behind the scaffold. Wait 24 hours for the silicone to cure. Put the cell into a container filled with water and rest a heavy object on top to prevent it from floating. Leave it in there for a couple of hours, and observe whether there is water in the air chamber. If there is water, remove the flange, cathode, and gas exchange membrane. Scrape off all silicone on the scaffold and repeat the above steps with a new gas exchange membrane. Once the SMFC is confirmed to be watertight, put the anode under the ring, and secure it using at least four 3D printed G-clips. Place the cap on the opening on top of the scaffold. This will ensure that rainfall and debris do not enter the air chamber. Strip at least 5 cm of titanium wire and insert it well into the anode. Repeat this for the cathode. The ends of the wire will connect to the SMFC's load with the anode being ground and the cathode being power.

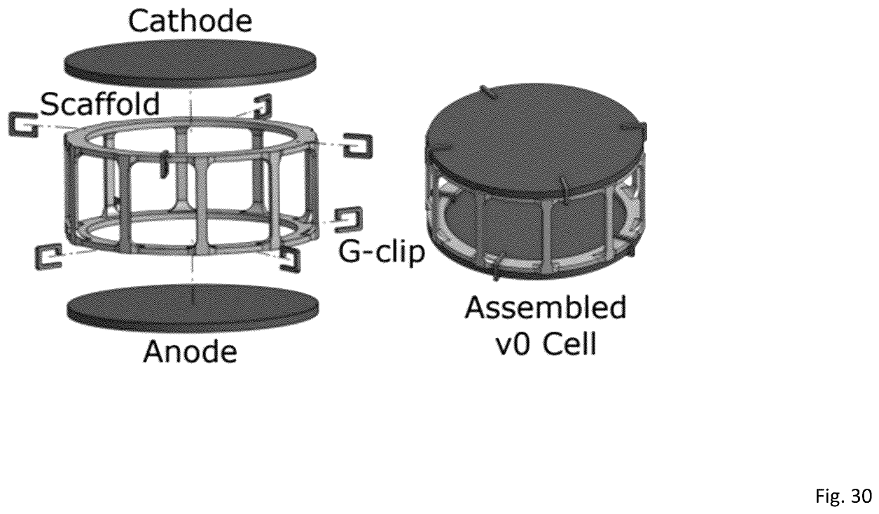

For assembly of the v0 cell, one can simply clip one of the graphite felt disks onto the scaffold with 4 clips exactly as discussed above for assembly of the v3.1 cell. Insert the titanium wires into each electrode. Leave the other electrode off the scaffold for now, since the inside of the cell needs to be filled with soil to form the electrolyte prior to installation. FIG. 30 depicts exploded and assembled views of a v0 SMFC in accordance with an illustrative embodiment. FIG. 20, discussed above, includes exploded and assembled views of the v3.1 SMFC.

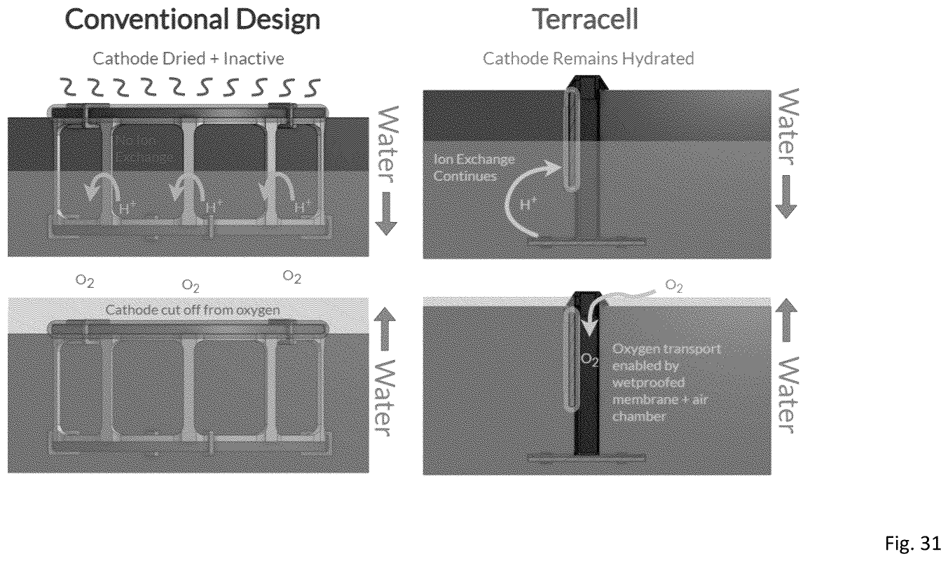

Thus, described herein is a system that integrates SMFCs with an ultra-low power circuit that operates continuously to modulate reflected signal from the environment to communicate with a receiver. The proposed design is an improved SMFC that generates power across a wider soil moisture range, and it works by vertically orienting the cathode to extend drying time and ensuring that it has reliable access to oxygen despite the soil being inundated. The proposed system improves the output power continuity of an SMFC to make it a more reliable energy source for electronics, and also increases the operational soil moisture range to make the device more adaptable to a variety of environments. FIG. 31 depicts a comparison of a conventional SMFC to the proposed SMFC in accordance with an illustrative embodiment. As shown, the proposed SMFC is able to operate in conditions that render traditional designs inoperable. The proposed system can be used in agricultural sensing, green infrastructure monitoring, wetland monitoring, smart cities, etc.

In one embodiment, the system integrates a terrestrial microbial fuel cell into wireless sensors that communicate using backscatter to enable soil-powered Internet of Things devices. The terrestrial microbial fuel cell serves as the power source for a low-power device that communicates to a receiver through modulating reflected signal sources instead of generating its own RF signal. This configuration allows the device's power consumption to decrease to the point where it can be entirely powered by a terrestrial microbial fuel cell. Specifically, the proposed technique integrates SMFCs with an ultra-low power circuit that operates continuously to modulate a reflected signal from the environment to communicate with a receiver. This method allows both sensing and wireless communication with just the power from the SMFC itself to enable soil-powered Internet of Things and other devices. The method improves the runtime of SMFC-powered devices from intermittently turning on every once in a while to continuous operation to provide higher-resolution data, and also decreases the cost of the overall device by eliminating the need for power conditioning circuitry.

In an illustrative embodiment, the system generates electricity by breaking down organic matter in the soil in order to power devices. The system includes a pair of conductive electrodes, one of which hosts microbes that break down organic matter to perform oxidation and release electrons. The other electrode serves as the cathode that is oriented vertically in soil so that it maximizes the time it takes to dry out. In an illustrative embodiment, one side of the cathode is permanently kept in air so that it can perform a reduction reaction even while the soil environment is inundated.

It is noted that the proposed SMFC system received the first-place prize from the 2024 Prototypes for Humanity award under the Energy section. This is a prestigious international technology exhibition with a focus on research-backed innovation with 2700+ submissions from 100+ countries this year. 100 teams presented in Dubai with 5 winners selected among the categories (Health, Environment, Energy, Data/AI, and Civil Society).

In an illustrative embodiment, any of the operations described herein can be performed by a computing device that includes a processor, a memory, a user interface (e.g., display, keyboard, mouse, etc.), a network interface (e.g., a receiver and a transmitter), etc. For example, the operations described herein can be implemented as computer-readable instructions which are stored on the memory. Upon execution of the computer-readable instructions by the processor, the computer performs the operations.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A microbial fuel cell device comprising:
a first conductive electrode that hosts a plurality of microbes that break down organic matter to perform oxidation and release electrons, wherein the first conductive electrode is an anode; and
a second conductive electrode operatively coupled to the first conductive electrode, wherein the second conductive electrode is a cathode that is vertically oriented in soil that includes the organic matter, and wherein at least a portion of the cathode is in contact with air.

2. The device of claim 1, further comprising a scaffold, wherein the first conductive electrode and the second conductive electrode mount to the scaffold.

3. The device of claim 2, further comprising a gas exchange membrane mounted to the scaffold, wherein the gas exchange membrane is positioned between the scaffold and the cathode.

4. The device of claim 3, wherein the gas exchange membrane comprises a 30% wetproofed carbon cloth.

5. The device of claim 2, further comprising a cap that mounts to the scaffold to help prevent material from entering the scaffold.

6. The device of claim 2, wherein the scaffold includes an air chamber that includes air such that one side of the cathode is exposed to the air.

7. The device of claim 6, wherein the air chamber is sealed such that the soil cannot enter the air chamber.

8. The device of claim 6, wherein a top of the air chamber is open such that air can enter the air chamber.

9. The device of claim 1, wherein the anode is horizontally oriented in the soil such that the anode is perpendicular to the cathode.

10. The device of claim 1, wherein the cathode is spaced apart from the anode such that there is a layer of the soil in between the cathode and the anode.

11. The device of claim 1, further comprising a sensor connected to the device, wherein the sensor includes a capacitor that receives a direct current (DC) voltage from the device.

12. The device of claim 11, wherein the sensor includes an oscillator that converts the DC voltage into an alternating current (AC) signal, and wherein the AC signal has a frequency that changes depending on a capacitance of the capacitor in the sensor.

13. The device of claim 12, further comprising a radio frequency (RF) analog switch and an antenna that is connected to the RF analog switch, wherein the AC signal is backscattered by the RF analog switch and provided to the antenna for transmission.

14. The device of claim 11, wherein the capacitor includes an insulated wire in combination with a co-planar capacitor.

15. A method of forming a microbial fuel cell device, the method comprising:
forming a scaffold;
forming a first conductive electrode that hosts a plurality of microbes that break down organic matter to perform oxidation and release electrons, wherein the first conductive electrode is an anode; and
forming a second conductive electrode as a cathode;
mounting the first conductive electrode and the second conductive electrode to the scaffold such that the second conductive electrodes is operatively coupled to the first conductive electrode, wherein the second conductive electrode is mounted to the scaffold such that the second conductive electrode is vertically oriented in soil that includes the organic matter.

16. The method of claim 15, wherein forming the scaffold includes forming an air chamber in the scaffold, and wherein the second conductive electrode is mounted to the scaffold such that at least a portion of the second conductive electrode is in contact with air in the air chamber.

17. The method of claim 16, further comprising mounting a gas exchange membrane to the scaffold such that the gas exchange membrane is positioned between the air chamber of the scaffold and the cathode.

18. The method of claim 15, further comprising mounting the anode to the scaffold such that the anode is horizontally oriented in the soil and such that the anode is perpendicular to the cathode.

19. The method of claim 15, further comprising mounting the cathode to the scaffold such that the cathode is spaced apart from the anode and such that there is a layer of the soil in between the cathode and the anode, and wherein the layer of soil operatively connects the cathode to the anode.

20. The method of claim 15, further comprising connecting a sensor to the device, wherein the sensor includes a capacitor that receives a direct current (DC) voltage from the device.
